(19) United States
(12) Patent Application Publication
(10) Pub. No.: US 2012/0041880 A1
(43) Pub. Date: Feb. 16, 2012

(54) SYSTEMS AND METHODS FOR DEALING CONTENT

(76) Inventor: Saar Shai, Kochav Yair (IL)

(21) Appl. No.: 13/263,748

(22) PCT Filed: Apr. 12, 2010
(86) PCT No.: PCT/IB10/51558

§ 371 Date: Oct. 10, 2011

Related U.S. Application Data
(60) Provisional application No. 61/168,253, filed on Apr. 10, 2009.

(51) Int. Cl. G06F 21/00; G06Q 30/06

(52) U.S. Cl. 705/51; 705/26.1

(57) ABSTRACT

Systems and methods for dealing or exchanging content and currencies in transactions involving multiple users, whereas traded may be rights to content, such as copyrights, and bandwidth capacities.

### BACKGROUND OF THE INVENTION

The present invention is in the field of electronic commerce. More particularly, the present invention is in the field of transactions over networks or the Internet.

Conventional content hosting and/or delivering (e.g. streaming) platforms, or otherwise distributing or providing platforms, such as web-portals, websites or web-based applications, facilitate the consuming (e.g. downloading) of content by users. Some are free, making their profit from traffic (such as by utilizing advertisements), whereas others are payment-based, such as by selling memberships, collecting fees, or receiving any other type of payments in exchange for access to content. However, there exists a need for innovative systems and services which feature or facilitate new methods and means for content consumption, as known systems and services are facing issues requiring solutions. For example, content is being easily pirated between users which copy and share content after it has been published. Accordingly, creators and producers of content are not always properly compensated for their efforts and/or investment. Another issue is lacking the ability to charge for certain types of user-generated content, or to commercialize it such that the creator of the content will be properly paid for his creation.

Following the above, embodiments and methods of the invention solve issues facing state-of-the-art electronic commerce systems and services.

### BRIEF SUMMARY OF THE INVENTION

Embodiments and methods of the invention provide novel ways for dealing content, such as novel types of transactions including content.

Some embodiments and methods of the invention provide novel ways for rewarding owners of content (e.g. creators, producers and/or distributors) and payers for content.

Various embodiments of the invention provide systems for trading content, whereas various methods of the invention facilitate providing services related to content.

In some embodiments and methods, content is published, or otherwise made available for a community of users, after a certain amount (or sum) of payments has been paid. Said certain amount may correspond to a set price for said content, or specifically for publishing said content. Said payment may be paid by (or otherwise “collected from”) a group of users, submitting payment separately or together.

In some embodiments and methods, users who paid for content more than other users and/or earlier than other users (such as in the process of collected the aforementioned certain amount of payments) receive more credit points then other users and/or other benefits which are not awarded to other users, such as an increased bandwidth for downloading said content (i.e. a higher (or “larger”) bandwidth may be allocated for users which paid more and/or earlier than others), or such as a larger increase in community rating, reputation points and/or virtual trophies.

In some embodiments and methods there is a payments count which may or may not be visual indicated to users, such as visually indicated by displaying a payment “bar” which illustrates the amount of each payment, which user made each payment and/or when each payment was made.

In some embodiments and methods, a creator or producer of content waives ownership rights (or copyrights) to the content and is compensated by receiving different payments from a plurality of different users. Compensating said creator or producer which donates the content to the public domain may help reduce content piracy as known in file sharing.

### BRIEF DESCRIPTION OF THE SEVERAL VIEWS OF THE DRAWING

FIG. 1A is a flowchart of a method of the invention;

FIG. 1B is a flowchart of a section of methods of the invention;

FIG. 1C is a flowchart of a section of methods of the invention;

FIG. 1D is a flowchart of a section of methods of the invention;

FIG. 2A is a schematic diagram of an embodiment of the invention;

FIG. 2B is a schematic diagram of a section of an embodiment of the invention;

FIG. 2C is a schematic diagram of an embodiment of the invention;

FIG. 2D is a schematic diagram of an embodiment of the invention;

FIG. 2E is a schematic diagram of an embodiment of the invention;

FIG. 3A is a schematic layout of an embodiment of the invention;

FIG. 3B is a schematic layout of an embodiment of the invention;

### DETAILED DESCRIPTION OF THE INVENTION

Note that for the described herein, the term “content” may be any form of information or data (e.g. file, program, code, etc.) which can be consumed by users and/or which can be computed by computational devices or mechanisms, and/or stored, and/or transferred between devices and/or systems, such as in a network (e.g. a servers network) or in a connection between two or more device (e.g. computers or mobile-phones). Content, in accordance with the described herein, preferably has value, such as by having certain desirability among users, and preferably can be consumed by user, such as downloaded (or in any way received), viewed, played, utilized, etc. For example, content may be a song or music track in the form of a file (e.g. an MP3 file, as known in the art). For another example, content may be software, such as a computer application or a widget for mobile phones (e.g. “smart phones”) or for handheld devices (e.g. personal digital assistant or gaming console). For yet another example, content may be a tool (e.g. a browser toolbar) or a development kit (e.g. an SDK). For yet another example, content may be an upgrade, plug-in, add-on or patch for software, as known in the art for computer applications. For yet other examples, the content may be a movie or picture, arts or crafts (e.g. a drawing, a 3D model, a set of color-swatches, an actions' macro, a game or a stage thereof such as a level fabricated or devised by a user by utilizing a development kit of the game), a book (e.g. an “e-book”) or article, a recipe, a code (e.g. a segment of code which may be useful to programmers) or hack or crack or fix (e.g. a so-called “hotfix”). For yet other examples, content may be a map, or information which can be integrated into a map (e.g. directions or instructions). Similarly, content may be a panoramic rendition of multiple pictures or a picture which can be utilized for a panoramic rendition. For yet other example, content may be information relevant to, certain users (e.g. gossip, news and/or weather report, opinions, etc.) and/or information which is the result of labor and/or related to certain expertise (e.g. consultation or estimation, such as an estimation of the odds of a certain result of a sports match, which can be provided by an expert in the field).

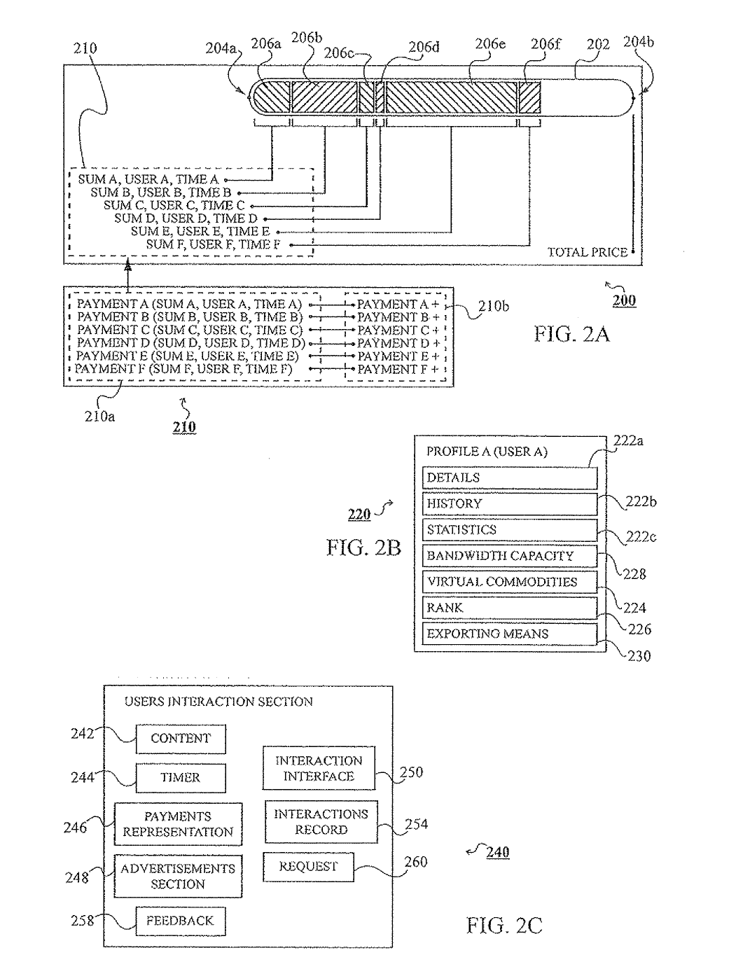

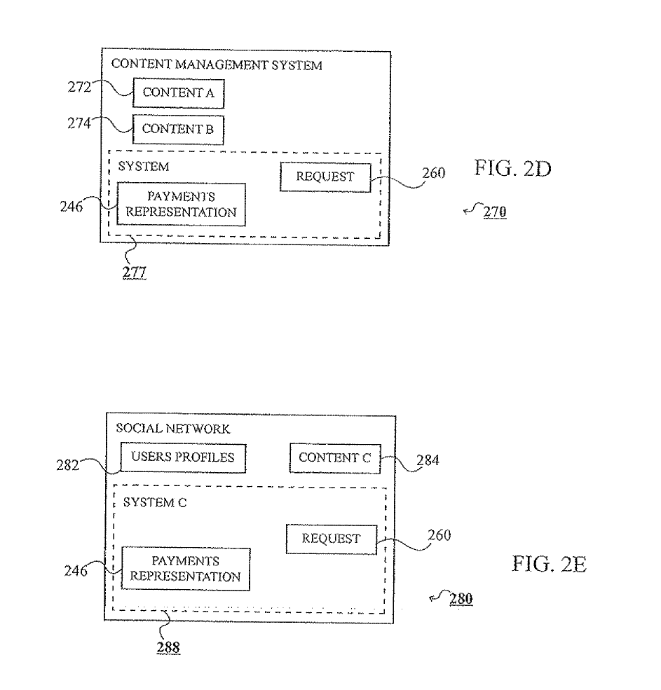

Further note that for the described herein, the term “user” may refer any human (e.g. a person or individual operating a device and/or program to interact with a system of the invention), or any program, device or mechanism designed to perform operations or actions described herein for “a user” (or plurality thereof), such as on behalf of a person or such as by being controlled by a person. The term “user” may similarly refer a team or group (e.g. a band or forum), or an organization, establishment, company, partnership, cooperation, business or commercial party or entity. For example, a user may be a person operation a computer and browsing a website of a system of the invention or utilizing a users interaction section (see ref. the described for step 116 of method 100, and users interaction section 240 as shown in FIG. 2C) to interact with the system. For another example, a user may be a so-called “bot” program (as known in the art for programmed performing automated tasks) which may have been program by a person to access a system of the invention and interact with it according to a set of conditions set by said person. For another example, a user may be a social group, such as a group of members in a social network website, or such as a community of people registered to a message board. For yet another example, a user may be a company, the marketing representative thereof may be interacting with a system of the invention on behalf of said company.

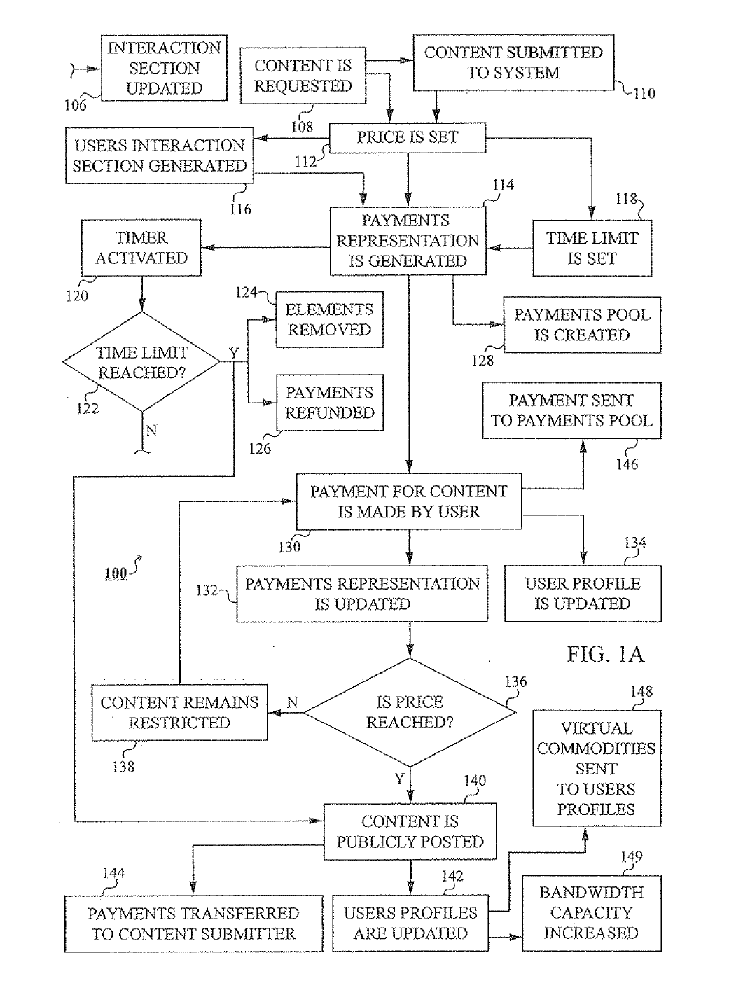

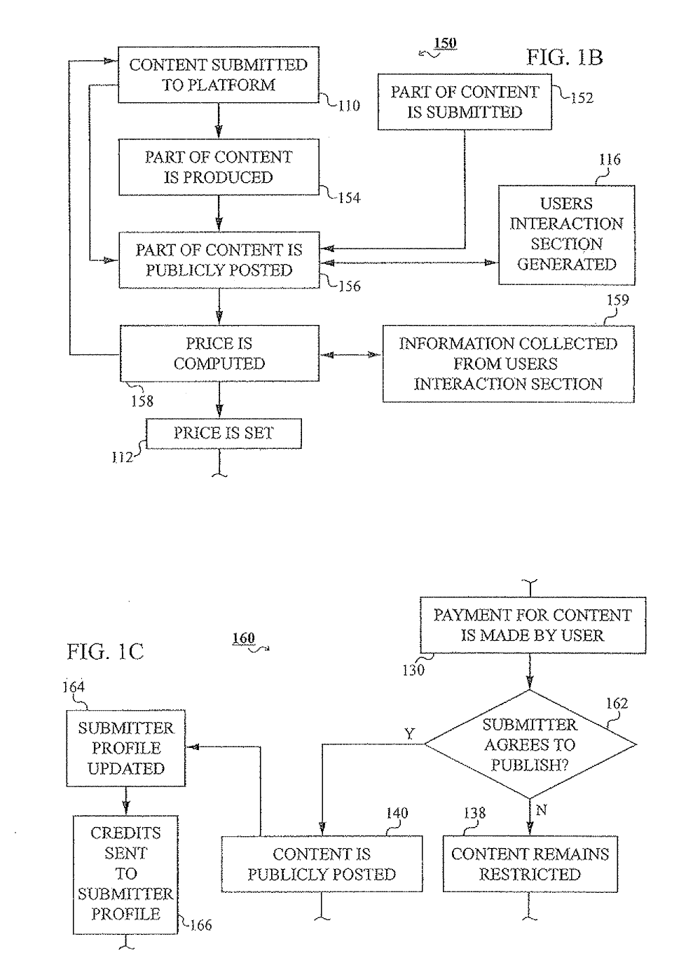

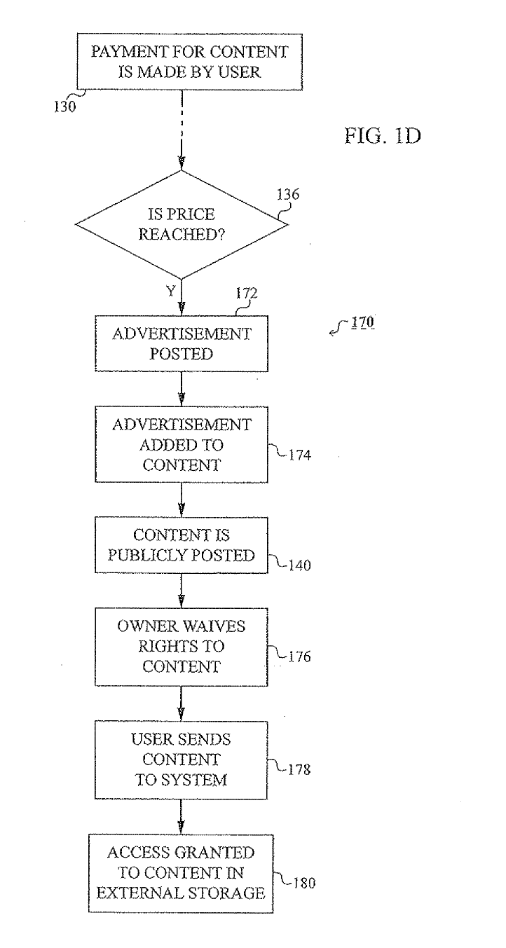

Referring now to the invention in more detail, in FIG. 1A there is shown a flowchart of a method 100. Method 100 may be a method for dealing (or otherwise exchanging or trading) content and payments.

In some methods, at a step 110, content may be submitted to a system. The system may be (or may include) any system (e.g. network of devices), platform (e.g. a computer architecture and equipment, such as a server running a software), and/or web, network or online entity (e.g. a website or an online service which can host content and to which users may log in or otherwise connect). Preferably, the system can facilitate the described for methods of the invention. Accordingly, note that for the described herein (unless specifically stated otherwise) “the system” may refer to any embodiment of a system of the invention, or otherwise to any system which can perform or facilitate performing any number and/or sequence of steps of methods of the invention. Accordingly, any reference to “the system” as described herein may include an embodiment included in the scope of the invention.

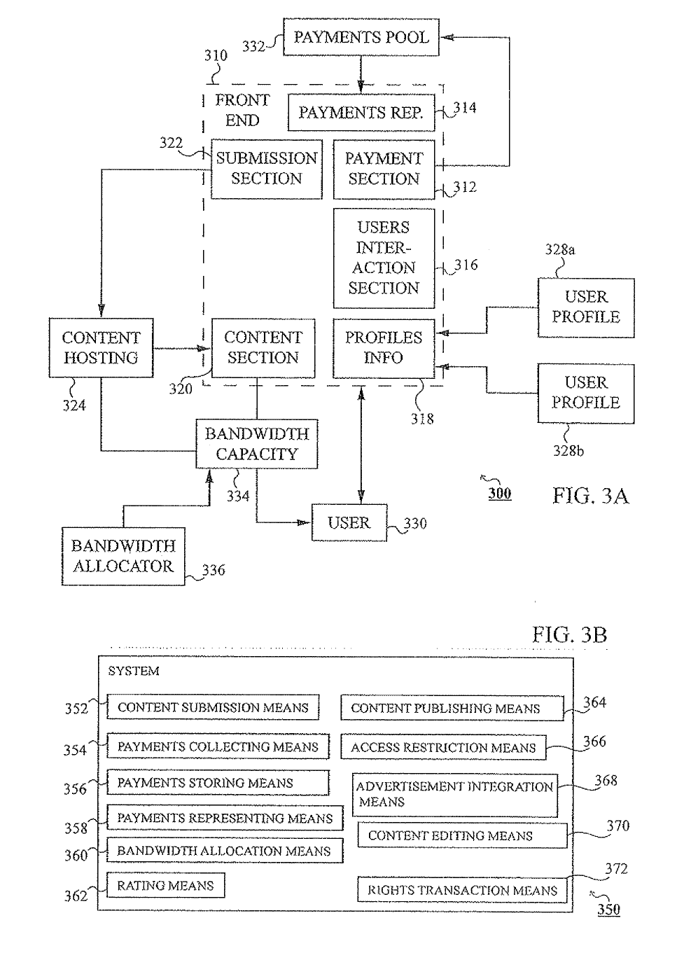

At step 110, content may be submitted to the system by any transferring of content to the system, such as by being uploaded (or otherwise sent) to the system or to a database or storage thereof (see e.g. ref. content hosting 324 of platform 300 in FIG. 3A), such as by or from a user. Alternatively, at step 110, a commitment or intention or desire to submit content may be registered, whereas the actual transferring of the content to the system may be pending or queued until certain terms have been reached (or “met”) or certain conditions occur (or “fulfilled”). For example, at step 110, a user may submit his/her willingness to receive payment for agreeing to publish content (in accordance with the described below for methods of the invention), whereas only when receiving payment does said user send the content to the system (preferably to be published). Accordingly, the described herein for submitted content may refer be content which was actually submitted to the system, or which the submitter submitted his/her (or “its”, or “theirs”, when referring to a user which is an entity of more than one individual) commitment, intention or desire to submit content, whereas the described herein for submitting content may refer to actually transferring content to the system, or to registering a commitment, intention to desire to submit content.

In some methods, content submitted to the system may remain restricted until (also “unless”) publicly posted (or “published”). In other words, users cannot access (or are prevented from accessing) the content until it has been publicly posted (see ref. step 140). Note that accordingly, and according to the described for step 140, “paying for content” and “payments for content” may refer to paying for content to be publicly posted, and/or for the submitter to waive right to content.

A user which submitted content, or submitted a commitment or intention or desire to submit content (step 110), which may be referred to simply as “the submitter”, may be any user which owns that content (or in other words “to which that content belongs”) or which owns or possesses any or all rights to that content. The submitter may, for example, be the creator, producer, author, editor and/or distributor of that content (i.e. content which may have been submitted to the system or which the submitter submitted his/her commitment, intention or desire to submit, which may be referred to simply as “submitted content”).

In some methods, at a step 112, a price for the submitted content may be set. Said price (referred to as “the price” for the described for method 100) may be (or correspond to) an amount (or “sum”) and/or value to be paid for the content to be publicly posted (or otherwise made accessible or available to users). The price may be of (or defined by) any measurement, amount, count, quantity, value or sum of currency (e.g. money, or more specifically dollars or euros) or commodity, or of any measurable and/or countable elements, units or values, such as points or credits.

Optionally, the price (set at step 112) may be set by the user which submitted the content to the system (i.e. the submitter), by any other party (or plurality thereof) such as by other users of the system, and/or by the system (see e.g. the system computing the price for submitted content at a step 158 of section 150 in FIG. 18). For example, the submitter may input an amount defined by the system as “requested price”, which may be the total amount the submitter wishes to receive for allowing access to the submitted content and/or for waiving rights to the submitted content (see ref. the described for step 140). For another example, at step 112, a group of users may request a certain content (see e.g. step 108), such as English subtitles for a foreign movie, specifying a price said group is willing to pay for said certain content. Note that in some methods, step 112 may be performed before step 110, such as in case a request for content (step 108) is directly followed by setting a price of that content. For another example, the price may be automatically set (step 112) by the system according to several factors, such as according to a price previously paid to publicly post other content of the same user (i.e. the submitter), and/or such as according the community rating or reputation rank of the same user (e.g. as appearing in a user profile, see e.g. rank 226 in user profile 220 in FIG. 2B).

Note that in some methods, the price set at step 112 may be posted (otherwise revealed to any user), such as in an additional step of method 100. For example, the price may be represented as the scale or size of a payments bar (see e.g. payments representation 200 in FIG. 2A). For another example, the price may be specified in any section of the system with which users interact (e.g. a webpage designed for submitting payments for content), such as on a users interaction section of the system (see ref. the described for step 116). In other methods, the price may be confidential. For example, the system may not provide users with information about the price (preferably users which did not take part in setting the price). This may be beneficial in case the submitter may wish to first review how much users are paying (e.g. at which rate and the average amount) before setting a price for publicly posting the content (see ref FIG. 1C).

In some methods, at a step 114, a payments representation is generated in (also “on”, or “at”) the system. The payments representation may be any representation of payments made for content submitted at step 110. In other words, the payments representation may be descriptive of payments of users (see ref. step 132). Optionally, the payments representation may be, or may include, a listing or count of payments. For example, once content has been submitted and the price for that content has been set, a webpage may be generated for facilitating paying, the webpage may include a specification or report of payments made by utilizing that webpage (preferably payments for the content mentioned for the example).

In some methods, the payments representation (generated at step 114) may be visual and may optionally be posted, such as by being made visually available for users (e.g. in a webpage, or as information sent to a program which visually renders the payments representation and which may be utilized by users).

In some methods, the payments representation may include a starting point, and/or an ending point which may correspond to the price set at step 112. Accordingly, the starting point may represent an initial amount for payments, such as a minimum amount for the first payment, or such as zero, from which payments start to accumulate. Further accordingly, the ending point may represent the price set at step 112, i.e. a sum to which payments need to amount to for content to be publicly posted (see ref. step 112). The ending point may be described, in other words, as a goal or limit for payments, and may be utilized to notify users of the price set at step 112. Note, accordingly, that the payments representation generated at step 114 may include a representation of the price set at step 112, or may include a reference thereto, or otherwise may in any way relate to the price.

In some methods, the payments representation may be graphic, such as in the form of a chart or bar (see e.g. payments representation 200 in FIG. 2A).

In some methods, the payments representation is influenced by payments made by users (see ref. step 132), or by registered intentions or commitments of users to pay. In other words, the payments representation may change (or “be changed”, “be altered”, or “be modified”) correspondingly to payments and/or intentions or commitments to pay. Note that accordingly, and as described herein for paying for content (see ref. step 130), or more specifically for paying for content to be published or posted, a payment may refer to any value or measurement (e.g. amount of currency or and/or credit) transferred to the system (or to a section thereof, or to users thereof), or any action of such a transfer or related thereto (e.g. the action of a user approving the transferring of money to the system, or to a section thereof), and/or may refer to submitting and/or registering a commitment of a user (or plurality thereof) to perform a payment (or plurality thereof) in the future (e.g. in later steps or in later time) or once certain terms have been reached or certain conditions occur (see e.g. step 136). Accordingly, a payment may also refer to a registration or record (e.g. a database entry or a file) of such a commitment. Such a commitment may, for example, be any notification, authorization or acknowledgement of the intention or willingness (or more strictly “obligation”, in some methods) of a user (or plurality thereof) to pay.

Referring to the previous paragraph, an example of an influence of payments of the payments representation may be, in case the payments representation is posted as visuals, or specifically graphics, a visual change corresponding to the payments as they are made (or after which). For a more specific example, in case the payments representation is (or includes) a bar, the bar may be “filled-up” by visual elements (e.g. rectangles), the size of each may represent a sum paid (i.e. represent the amount of a payment made), such as shown in FIG. 2A. In a similar example, a marker of the bar moving towards an ending point (see ending point mentioned above) of the bar correspondingly to sums paid.

Note that an embodiment of a payments representation of the invention is shown in FIG. 2A (payments representation 200).

In some methods, a users interaction section is generated at a step 116. Preferably, the users interaction section is posted, or otherwise access thereto is granted to users. The users interaction section may be any section of the system, whereat users may interact with the system. Preferably, the users interaction section facilitates paying for content. Additionally or alternatively, the users interaction section may include the payments representation (optionally generated at step 114) or may facilitate viewing (or otherwise “accessing”) the payments representation, and/or the price (set at step 112) and/or the time limit and/or the time (see ref. step 118), and/or any other information related to the submitted content and/or to the submitter. Further additionally or alternatively, the users interaction section may facilitate any interaction between users, such as chats (e.g. in a chat room), exchanging messages (e.g. in a comments area) and/or conduct discussions (e.g. in a message board or forum), and such as specifically exchange information (e.g. messages) related to submitted content and/or the user which submitted the content (step 110).

In some methods, the users interaction section may be generated specifically for facilitating paying for submitted content (or otherwise any execution of step 130), such as in case the users interaction section a webpage designated for viewing the payments representation and for paying for submitted content.

In some methods and in some embodiments, the users interaction section may include any information or any number of details related to users, payments and/or the submitted content (see e.g. ref. information 222a-c in FIG. 2B and ref. profiles info 318 in FIG. 3A), such as how much money each of the users participating in a discussion paid for the submitted content, and/or the file size and/or duration of the submitted content (in case the submitted content is a movie).

Note that an embodiment of a users interaction section of the invention is shown in FIG. 2C (users interaction section 240).

In some methods, a time limit for paying for submitted content may be set at a step 118. The time limit may define a period of time in which paying for the submitted content is permitted (or “allowed”, or “enabled”).

In some methods, at a step 120, after (or while) the payments representation is generated (optionally at step 114), and/or after (or while) the users interaction section is generated, a timer (optionally set at step 118) may be activated. The timer may count or measure time passing from generating the payments representation and/or the users interaction section, or approximately from thereon, such as from shortly before the generating.

In some methods, a check for whether the time limit (optionally set at step 118) is reached is performed at a step 122. The check may be performed by the system, or by any section or function, such as any section or function designed to access the timer (optionally activated at step 120) or compute information from the timer. The time limit may be reached if (or when) the time which passed from the activation of the timer (step 120) is equal to the time limit (optionally set at step 118), or if more time had passed compared to a period of time defined by the time limit.

In some methods, if the time limit (optionally set at step 118) is not reached, such as in case the result of a check at step 122 is negative—further steps of methods of the invention may be performed or continued to. For example, if the time limit is not reached, the progress of method 100 may be directed to any execution of step 130.

In some methods, if the time limit is reached (i.e. more time has passed compared to the time limit, optionally since a timer was activated at step 120), such as in case the result of a check at step 122 is positive—any element generated in the process of method 100 before the time limit was reached (e.g. the payments representation and/or the users interaction section, or any elements therein or thereof, such as information posted in the users interaction section or representations of payments in the payments representation) may be removed, erased, stopped or hid.

In some methods, if the time limit is reached (additionally or alternatively to the described above)—payments made so far (i.e. made until the time limit is reached) may be refunded at a step 126. For example, if the price (which may have been set at step 112) for submitted content is not matched by the total value of payments made within a certain time limit, a webpage devoted to the submitted content, which may include a payments representation and/or a users interaction section, may be removed from the system, whereas payments made within said certain time limit may be refunded to users who made the payments.

Note that in some methods step 124 may be omitted, whereas in other methods step 126 may be omitted. Further note that step 122 may be performed at any time during the steps of method 100, or at any time during the process or progress of performing the method. Accordingly, a check for whether a time limit is reached may be performed at any time, and any number of times, during the progress of the method.

In some methods, a payments pool may be created at a step 128. The payments pool may be, or include, any storage (e.g. an account, a fund, a deposit or an escrow) and/or record (e.g. listing, database, log or archive) of payments made for submitted content. The payments pool may include or relate to any information related to payments (e.g. the amount thereof or the time at which they were made) and/or users who paid (e.g. system profile references or otherwise personal information). For example, the payments pool may be a temporary bank or credit account, or an escrow mechanism, in which payments (preferably payments performed by users, as described for step 130) are stored, or to which payments are transferred or collected, until a total amount of payments (preferably corresponding to the price set at step 112 is reached (or otherwise until any other conditions occur). For another example, a payments pool may include a datasheet (or “spreadsheet”, or “worksheet”) of users who paid (e.g. at multiple executions of step 130), and of the sums each user paid.

Following the above, it is to be made clear that the payments pool, as described herein, may refer to a storage of payments, and/or may refer to a record (or plurality thereof) of payments. Note that an embodiment of a payments pool of the invention is shown in FIG. 2A (payments pool 210).

In some methods, the payments pool created at step 128 (or simply “the payments pool”) may be visually represented by the payments representation. Accordingly, the payments representation may be descriptive (or “representative”) of the payments pool, or of any section or element, thereof. For example, the payments representation may include a graphic pie chart of a listing included in the payments pool (e.g. stored as a file on a server of a system of the invention), such as by retrieving information from said listing and rendering said graphic pie chart.

In some methods, at a step 130, a payment for submitted content is made by a user. As noted above, a payment (or plurality thereof), for the described herein, may refer to any value or measurement (e.g. amount of currency or and/or credit, which may be in the form of digital information for being received through a network) transferred to the system (or to a section thereof, or to users thereof), or any action of such a transfer or related thereto (e.g. the action of a user approving the transferring of money to the system, or to a section thereof), and/or may refer to submitting and/or registering a commitment (or “obligation”) of a user (or plurality thereof) to perform a payment (or plurality thereof) in the future, or once certain terms have been reached or certain conditions occur (see e.g. step 136). Accordingly, a payment may also refer to a registration or record (e.g. a database entry or a file) of such a commitment. Similarly, a payment may be an agreement (or the establishment and/or registration thereof) between users, or between a user (or plurality thereof) and the system. Further similarly, a payment be any approval, statement, declaration, indication, notification, verification, authorization or acknowledgement of the obligation (or, in some methods, less strictly, the willingness or intention) of a user (or plurality thereof) to pay.

Preferably, each user making a payment decides how much to pay, so that payments of different users are different, such as in amount, type and/or value. Accordingly, the amount, type and/or value of each payment may be determined by each user making a payment, such as according to his/her discretion or considerations.

Following the above, at step 130, a user may transfer currency (e.g. to the system or to another user of the system, such as the user which submitted content at step 110), or otherwise currency (or any other measurable, countable or valuable elements, units or values) may be transferred and/or received. Similarly, at step 130, a user may submit a commitment (e.g. by sending a digital or electronic signature), or register an intention, to transfer currency, or otherwise such a commitment or intention may be registered (or otherwise received and/or recorded). For example, at step 130, a user (e.g. a member of a website of the system) may declare he is willing to pay a certain sum of money, or a certain amount of credit points, for the publication of certain content. The declaration of said user may be submitted to and/or registered at the system, such by said user interacting with the system or with a section thereof (e.g. by said user inputting text, operating controls (e.g. a link or key), or sending a code to the system). Interaction with the system may be facilitated by logging into it or connecting to it (e.g. loading a webpage of the system in a web-browser software).

Optionally, the payment is made to the payments pool (optionally created at step 128). In some methods, the payment (made at step 130) is made (e.g. transferred or performed) promptly, whereas in some methods the payment may be queued or pending until certain terms have been reached or certain conditions have occurred. For example, the payment may be a sum of money which may be transferred to the system after the details of the credit card of the user paying are verified (e.g. through an online banking service). For another example, the payment may be a commitment of a user to pay a certain amount of currency, whereas the actual transferring of said certain amount of currency may be queued until the total sum of currency which other users committed to pay amounts to the price set at step 112, at which time said certain amount of currency which said user committed to pay is transferred to the system.

Following the latter example, at some methods, the commitment of a user to pay (for publicly pasting the content submitted at step 110), as made at step 130, may be put into practice if (or when) the sum total of payments other users committed to pay (preferably together with the payment said user committed to pay) is equal the price set at step 112 (see ref step 136). For example, a user may register a willingness (as an exemplary commitment, which may or may not be binding) to pay a certain amount of credit points for the content (submitted at step 110) to be publicly posted, but is not required to actually pay (e.g. transfer said credit points) until a total price for publicly posting the content is reached or until other users register their willingness to pay additional amounts of credit points which, together with said certain amount of credit points (said user is willing to pay), add up to the price set at step 112.

Note that it is to be made clear that step 130 may be executed any number of times by any number of users. For example, multiple users may pay for submitted content, either simultaneously or at different times (such as by a sequence of executions of step 130). For another example, multiple events of paying for submitted content by a user may occur during the process or progress of some of the methods of the invention.

Following the above, a step of a method of the invention may be, or may include, multiple executions of the described for step 130, specifically multiple payments made by multiple users.

In some methods, as noted above, payment made at step 130 may be sent (or “transferred”) at a step 146 to a payments pool (optionally created at step 128), or may be registered thereat. Otherwise, at step 146, the payment made at step 130 may cause any change to the payments pool, preferably a change corresponding to the payment. For example, at step 146, the payment may be registered or otherwise recorded in (or “at”) the payments pool, or specifically in a database thereof. For another example, in case the payments pool is a bank account, the sum of money paid at step 130 may be transferred (e.g. from a user's bank account) to the payments pool at step 146.

Note that in some methods, in case payment made at step 130 a commitment of a user (in accordance with the described above for “the payment”), sending of the payment to the payments pool (at step 146) may refer to any recording of said commitment of said user in the payments pool. Otherwise, sending of the payment to the payments pool may refer to sending any information about (or related to) said commitment. For example, the payments pool may be a listing holding information about users and their commitments to pay certain sums (as opposed to the payments pool being a storage of actual sums, as in other methods of the invention), so that when a user commits to pay a certain sum (at step 130 in some methods), the commitment (or a information thereabout) may be sent to said listing (at step 146 in some methods), such as to be logged thereat.

In some methods, at a step 132, a payments representation (optionally posted at step 114) is updated correspondingly to the payment made at step 130, and/or correspondingly to updates to the payments pool (optionally created at step 128) which are caused by the payment being made at step 130 (as described for step 146 for payment sent to the payments pool).

In some methods, updating the payments representation (step 146) may be (or may include) visually representing the payment made at step 130 (preferably by updating, or otherwise changing the payments representation). In other words, the update to the payments representation may include any visual representation of the payment made at step 130, or any visual change which is descriptive of the payment. For example, after the payment is made by a user (step 130), the payments representation is added a representation of the amount paid by said user (e.g. a graphic element descriptive of said amount and optionally also of said user). For a more specific example, in case the payments representation is a payments bar having a graphic marker which marks the total of all payments made, the payment at step 130 may prompt said market to move closer to an ending point of the payments bar (preferably said ending point representing the price for publishing a submitted content), whereas the movement of said marker may correspond to the payment (made at step 130), such that after step 130, and in accordance with step 146, said marker marks a new total of all payments (which then includes the payment made at step 130). For another example, the payments representation may visually represent the payments pool such that when the payment is sent to the payments pool, or otherwise the payments pool is updated correspondingly to the payment (in accordance with the described for step 146), the payments representation is updated with respect (or “correspondingly”) to the change in the payments pool.

In some methods, the profile of the user who made payment at step 130 may be updated at step 134. The profile of the user (simply “the user profile”) may be (or may include, or be included in) any section of (or “in”) the system associated with that user, such as an account, membership or personal webpage. Alternatively, the profile may be (or may include, or be included in) any program and/or device which is owned and/or operated (or controlled) by the user (who made payment at step 130), which is not necessarily a part of the system but which may be interacting or communicating with the system. For example, the profile may be a section of the system (e.g. an account of webpage) registered to or associated with the user. For another example, the profile may be an application or software (and/or a computer running it) with which the user interacts with the system.

In some methods, the update at step 134 may be any change or modification related to the payment made at step 130, or any change or modification which corresponds to the payment. The change may be of (or to) any number of elements or sections of the profile, or a change of any information or details therein. For example, a commitment of a user to pay a certain amount for content (as an exemplary payment made at step 130) may be posted on said user's system profile. For another example, when a user has made payment for content, a certain rating included in the user's profile (e.g. community rating or “payer rank”) may be updated (preferably increased).

in some methods, at a step 136, a check for whether the price (optionally set at step 112) is reached is performed. The price is reached when the total amount of payments made (or transferred, or collected, or registered, or recorded) reached (i.e. is equal or higher than) the price set at step 112. In other words, at step 136, the sum (or collection, or value) of payments made by users is compared to the price set at step 112. Said sum may be of all the payments in the payments pool (optionally created at step 146), or a record of all the payments that were made, as recorded in the payments pool.

Checking whether the price is reached (or comparing the sum of payments to the price) may be any function, process, operation, execution or procedure which can be performed or facilitated by the system. Accordingly, the checking may be performed by any element, part, unit, section, module or component of the system. For example, an application or software of the system may include a code which can be executed for the purpose of adding all payments made by users and matching the result with the price set for publishing the content (for which said users paid). For a more specific example, after several payments are made by users, the sum of the payments (i.e. a total of adding all the payments) is equal to a price previously set for allowing access for users to submitted content. As each user makes each payment, the amount of each payment may be added to the sum of all payments previously made, and a representation of the payments may be updated correspondingly (e.g. may progress towards an ending point which marks represents the total price). Accordingly, when the sum of payments is equal to the price, the payments representation may be reflective of that. A program may check if the payments representation reflects a sum of payments which is equal to the price, such as in case the payments representation is a payments bar—checking whether said payments bar is filled up to an ending point (which optionally represents the price). Note that said program of the latter example may perform a check for a payments pool, which the payments representation optionally describes (alternatively to checking the payments representation).

In some methods, checking if the sum of payments may be for determining (or concluding, or deducing) to which step of the method to progress, or in other words for knowing (or otherwise ascertaining information about) which step of the method is to be performed next, or is to be continued to.

Note that step 136 may be performed at any time during the steps of method 100, or otherwise at any time during the process or progress the method. Accordingly, a check for whether the price reached (as described above) may be performed at any time, and any number of times.

In some methods, if the price is not reached (i.e. the sum of payments is lower than the price, in accordance with the described above), such as in case of a negative result to a check at step 136, the content (submitted at step 110) may remain restricted, or is not publicly posted, at a step 138. Optionally, then (i.e. after step 138) more payments can be made by users, such as by returning to step 130 (performing step 130 again, in other words). For example, no user may have access to submitted content until the result to the check at step 136 is positive, or otherwise until the price for publishing the content is reached, whereas more payments may be made until then (or otherwise while the check is negative).

In some methods, if the price is reached (i.e. the sum of payments is equal or higher than the price, in accordance with the described above), such as in case of a positive result to a check at step 136, the content may be publicly posted (or “published”) at a step 140. For example, a check of whether the price for submitted content is reached (optionally at step 136) may return a positive result (i.e. the price is reached), according to which said submitted content may be published.

In some methods, publicly posting (or “publishing”) content may refer to making submitted content (as described for content submitted at step 110) available (or “accessible”), such as for consumption (e.g. by downloading). This may include any repositioning or relocating of the submitted content in the system (e.g. from one database to another, or from one server to another, or from one address to another), or any change to information related to the submitted content, such as to an entry in a database which corresponds to the submitted content.

In some methods, at step 140, only users which paid for the content may be granted access to the content in other words, the content may be made available only to users which paid (optionally at step 130).

In some methods, at step 140, the content may become (or may be made) available to any user of a specific group of users, or to any user among users following any number of similar criteria or details. For example, the content may become available only to users which have user profiles (see e.g. user profile 220) which includes a rank (see e.g. rank 226) above a certain value.

In some methods, at step 140, the content may become (or may be made) available to any user of the system and only to users of the system. For example, only members or “registered users” of the system may access the content. Note that in such methods, ANY user of the system, regardless of having paid for the content or not, may be granted access to the content.

In some methods, at step 140, the content may become available to anyone, regardless of their relation or association to the system. For example, at step 140, the content may be distributed to other systems or services, such as to websites offering free content.

In some methods, publicly posting (or “publishing”) content (additionally or alternatively to the described above for making the content accessible) may refer to the system and/or to the user which submitted the content waiving some or all right to that content, such as copyrights. In other words, step 140 may be or may include any change in ownership of, or rights to, the submitted content. Preferably, publishing content (step 140) may include transferring rights for the submitted content (from the submitter of the submitted content and/or from the system) to the public domain. For example, at step 140, the submitter of content (e.g. the creator of the content and the owner of its copyrights) may submit a waiver (e.g. a signed legal document or a binding declaration) of rights to the content. The submitted content may accordingly become available by low for consumption by any person.

In some methods, at a step 142, the profiles of any or all of the users who paid for submitted content are updated (similarly to the described for step 134 for a user profile update as consequence of payment made). Optionally, each profile may be updated separately and/or differently. Alternatively, the profiles may be updated together and/or similarly. The update may be to any number of elements or sections of each profile, or to any information in each profile (see e.g. ref. information 222a-c in FIG. 2B).

In some methods, the profiles may be updated at step 142 if the submitted content (submitted at step 110 and optionally for which users paid at any number of executions of step 130) is publicly posted. In other words, the profiles may be updated at step 142 as a consequence (or following) a positive result to the check at step 136, or only consequently to the execution of step 140.

In some methods, updating the profiles of users at step 142, preferably users which paid for the content submitted at step 110 (and optionally published at step 140), may include sending (also “distributing, or “giving”, or “adding”, or “transferring”) virtual commodities to the profiles. Otherwise, in some methods, at a step 148, virtual commodities are sent to, and preferably received or registered at, the profiles of users which paid. Accordingly, note that the described for step 148 may be a specific example of executing step 142, or otherwise may be included in any execution of step 142.

In some methods, the virtual commodities sent at step 148 may be any number of elements, units or values, such as credits, points, rankings, ratings, scores, marks, certificates (also “certifications”), notifications, acknowledgements or otherwise any documentation, which can be utilized by the system and/or by any other system interacting with the system or which includes the system. Accordingly, the virtual commodities may be units (or any type of elements) defined by the system, or which the system can utilize (or “make use of”), compute and/or manipulate. For example, virtual commodities, as described for methods and embodiments of the invention, may be values in a counting scheme supported by the system (and/or by any other system communicating with the system). For a more specific example, in case the system is a website, virtual commodities may be points, any amount of which can be associated with a user of the system (e.g. a registered member of said website). For another example, virtual commodities may be, or include, trophies, awards and other so-called “achievements” as commonly known in gaming in “achievement systems” (see e.g. World of Warcraft game, and Xbox Live online multiplayer gaming delivery services).

Note that as described above for step 134, the profiles of users, as described for step 148 and step 142, may be (or may include, or be included in) any number of sections of (or “in”) the system associated with said users, such as an account, membership or personal webpage. Additionally or alternatively, the profiles may be (or may include, or be included in) any number of programs and/or devices which are owned and/or operated (or controlled) by said users (preferably users who made payments at any number of executions of step 130), which are not necessarily parts (or sections) of the system, but which may be interacting or communicating with the system.

In some methods, the virtual commodities sent to the profile of each user may correspond to (or represent, or reflect), or be in proportion to, a payment made by that user (e.g. in an execution of step 130). More specifically, in some methods, the sum, number, amount, type and/or value of the virtual commodities sent to the profile of each user may correspond to or factor (or “be based upon”, or “be influenced by”) the amount, type and/or value of the payment made by that user. In other words, the amount, type and/or value of the payment made by a user (optionally at step 130) may be a factor for determining the amount, type and/or value of the virtual commodities sent to the profile of that user (step 148).

Following the above, virtual commodities sent to profiles of users (in any number of executions of step 148) may include any representation of the payment each of the users made. For example, the amount of money (or any other currency) a user paid for content at step 130 may, in case the content is published (step 140), may be the same amount of credits or “virtual money” (as exemplary virtual commodities) said user is awarded (by his profile being updated at step 148). For another example, virtual commodities may be points, or units measured in points, whereas each point may correspond to an amount of money, such that the number of points transferred to a profile of a user (step 148) may be calculated (or deduced) by knowing (or ascertaining) how much money said user paid for content. For a more specific example, virtual commodities of the system (or otherwise which are sent at step 148) may be credit units, whereas each credit unit may correspond to a dollar, such that three credit units may be transferred to a profile of a user who paid three dollars. Similarly, a user who paid a hundred dollars may receive a hundred credit units to his/her profile. For yet another example, a certain variable (e.g. a score) in a profile of a user who paid for submitted content may be updated correspondingly to how much said user paid, such as increased correspondingly to the payment made by the user.

In some methods, virtual commodities may be or include any number of visual elements, such as symbols, signs, icons, characters, illustrations, graphics or otherwise any visual depiction. Preferably, the visual elements may correspond or be representative or descriptive of payments (or specifically the amount, type and/or or value thereof), such as specifically the amounts thereof or the time at which they were made (in accordance with the described below). For example, the webpage (as an exemplary profile) of a user who paid for submitted content may be added an illustration of a medal (i.e. said illustration may be posted on the webpage), which denotes the fact that said user paid for submitted content. For another example, a mobile phone of a user (as an exemplary profile as described for the invention) may receive (e.g. via a WiFi or cellular connection, optionally by utilizing an email or file transfer application) a new wallpaper (as common in certain graphic user interfaces of mobile phones and other computers) which features additional graphic items than a previous wallpaper, in accordance with how much said user paid for content, and so said user may exhibit his/her mobile phone to others for proving or otherwise demonstrating how much he/she (or “it” or “they”, in some said user is an entity of more than one individual) had paid, such as to receive recognition from others, or such as to receive benefits from others (e.g. receive a discount at a restaurant which acknowledges virtual commodities as cause for providing discounts).

Following the above, virtual commodities, as described herein (such as described transferred to users profiles at step 148), may be traded, exchanged, or otherwise be part of certain transactions. For example, virtual commodities in any step of methods of the invention, and/or which are utilized by some systems of the invention, may be certified or accepted by third party retailers as valuable goods which can be traded for other goods. For a more specific example, virtual commodities may be similar to frequent flyers airline miles in that they can be exchanged for tangible commodities (flight tickets in the case of frequent flyers airline miles).

In some methods, the number, sum, amount, type and/or value of virtual commodities sent to profiles (step 148) may, additionally or alternatively to corresponding to the amount, type and/or value of payments, correspond to any number of factors (or details) other than the amount, type and/or value of payments.

Following the above, in some methods, the number, sum, amount, type and/or value of virtual commodities sent to a profile of a user may, additionally or alternatively to corresponding to the amount, type and/or value of payments, correspond to the time (or turn, as relative to other users) at which said user made the payment (at step 130), such as how soon after generating the payments representation (optionally at step 114) did the user make the payment. This may be because users which pay sooner than other users (i.e. at an earlier time or at an earlier turn) may encourage other users to pay and/or may be facing a higher risk for their payments, and so may be awarded by appropriate virtual commodities (preferably more virtual commodities than users which paid later). For example, after submitted content is published, a user which made the first payment for the submitted content may receives more credits (as exemplary virtual commodities) to his/her profile than any other user receives. This may be regardless of the amount of said first payment, yet in other cases may factor the amount of said first payment (in which cases said user may have also had to pay above a certain amount to receive more credits, yet said certain amount may be lower than such a certain amount for other users which paid later). For another example, a user which made the first payment for the submitted content receives to his/her profile a trophy (as an exemplary virtual commodity) representing the fact that he/she was the first to pay, optionally in addition to other virtual commodities sent to the profile which are in direct proportion to the amount of the first payment. Accordingly, note that some virtual commodities may correspond to the amount, type and/or value of the payment, whereas other virtual commodities may correspond to the time at which the payment was made, whereas yet other virtual commodities may correspond to both factors. For yet another example, a user which made payment for the submitted content receives to his/her profile a number of virtual commodities which is the result of a calculation which factors how much time passed from posting of a payments bar (as an exemplary payments representation) to the time the user paid, and optionally also factors how much was paid.

Note that it is made clear that any of the described for virtual commodities, or specifically the amount, type and/or value thereof, corresponding to payments made (or specifically the amount, type and/or value thereof) may similarly refer to virtual commodities, or specifically the amount, type and/or value thereof, corresponding to the time at which payments were made.

Note that it is made clear that profiles of users may include (or feature) virtual commodities which were not received at step 148. Virtual commodities which were not received at step 148 may have been received from any source, and by any operation, function or procedure, and as a consequence of any event or occurrence. Optionally, virtual commodities which were not received at step 148 may be the same type or kind and/or value of virtual commodities as virtual commodities which were received (or which can be received) at step 148, such as in case virtual commodities which can be received at step 148 may be the same type and/or value of virtual commodities received at processes not included in methods of the invention. Further optionally, virtual commodities which were not received at step 148 may be added to or joined with virtual commodities received (at a user profile, or sent thereto) at step 148, and vice versa, such as in case all virtual commodities in the profiles of users, no matter from which source or received at the profiles by any operation, may be added up to the same score. Additionally or alternatively, virtual commodities which were not received at step 148 may be a different type or kind and/or value of virtual commodities (see e.g. ref. other credits 226 in FIG. 28) than virtual commodities which were received at step 148 (see e.g. ref. credits 224 in FIG. 28), such as being different types of points of a different value.

Further note that in some methods, any of the described for step 148 may similarly refer to (or be included as part of) step 134, whereat the profile of a user which paid for content is updated regardless of whether the submitted content is eventually published or not. Accordingly, in some methods, virtual commodities may be sent (as an execution of step 134 or as a process or operation included in the execution of step 134) to a profile of a user which paid for submitted content, regardless of whether the submitted content is eventually publicly posted or not. Optionally, in case the updating of a profile of a user at step 134 includes sending virtual commodities to said profile—the virtual commodities (or the amount, type and/or value thereof) sent to the profile may be different than virtual commodities (or than the amount, type and/or value of thereof) sent at step 148. Accordingly and more specifically, in some methods, if a user paid for content which is not published (i.e. which is not yet published or which is not published anytime thereafter)—virtual commodities (or the amount, type and/or value thereof) may be sent to a profile of the user which are different than virtual commodities (or the amount, type and/or value thereof) sent to the profile during or after publishing the content. For example, a user paying for submitted content may receive to his/her profile virtual commodities which have a certain value (step 134), whereas if the content is eventually published, the user may receive to his/her profile more virtual commodities of the same value, or—virtual commodities which have higher (also “more”) value (step 148). This may be similar to receiving a certain type of virtual commodities for (or when) paying for submitted content (step 134), and receiving a different type of virtual commodities if and when the submitted content is published.

In some methods, at a step 149, bandwidth capacity for accessing (e.g. downloading or being presented with) submitted content (see e.g. ref. bandwidth capacity 334 in FIG. 3A), which has preferably been published at step 140, is increased for users which paid for the submitted content. In other words, more (or increased) bandwidth is allocated at step 149 for users which paid for the submitted content.

In some methods, at step 149, more bandwidth capacity is allocated for users which paid more for the submitted content. In other words, the bandwidth capacity allocated (or designated) for users which paid more (or “higher amounts”) for submitted content is increased more than the bandwidth capacity allocated for users which paid lower sums. Optionally, in some methods, the allocation or increase of bandwidth capacity (step 149) for each of the users which paid for submitted content may correspond to how much each of the users paid (i.e. to the payment of each user, or specifically to the amount, type and/or value of the payment). The allocation or increase may similarly correspond to when each of the users paid (additionally or alternatively to how much each of the users paid). For example, a user may have paid a hundred dollars for submitted content, whereas a second user may have paid two hundred dollars for the same content. Following the above, the bandwidth capacity for downloading the content allocated for said second user may be increased by twice as much as the increase in bandwidth capacity allocated for said first user. Notice that the latter example does not take into account the times at which said first and second users paid, yet it is understood that the increase in bandwidth capacity may additionally or alternatively correspond to said times.

In some methods, additionally or alternatively to the described above, the allocation or increase of bandwidth capacity, as described for step 149, may correspond to any number of factors or details, such as the duration of the period in which a user was registered at the system, whereas preferably the longer a user is registered at the system, the larger the bandwidth capacity allocated for said user.

As noted above for step 148, it is made clear that any or both of steps 148 and 149 may be performed before, after or during step 142, or otherwise may be processes, executions, procedures operations or functions included in step 142, i.e. may be included (e.g. as specific sub-steps) in updating profiles of users. For example, in some methods, step 142 may include several procedures, one of which may be the sending of virtual commodities to profiles of users as described for step 148.

In some methods, at a step 144, payments are transferred to the submitter of content (see ref. step 110), and/or commitments of users to pay are put into practice. Transferring of the payments (and/or putting to practice commitments to pay, as described for payments) may be automatic, such as by a program of the system automatically sending money, or may be manual, such as in case each payment is transferred by each user who paid for the content (or committed to pay) to the user who submitted the content. For example, payments may have been stored at a payments pool until the price (set at step 112) for submitted content is reached (according to a check at step 136), whereas when the price is reached—payments are transferred from the payments pool to an account (e.g. a bank account) of the submitter of the content. For another example, several users may have committed to pay certain amounts of money for submitted content, whereas the total sum of said certain amount of money may be equal to a price set for the publishing the submitted content. A check may confirm that said total sum is equal to said price, at which time (or consequently) the content is published and each of said several users transfers (or “is obligated to transfer”) the certain amount (which he/she committed to pay) to the submitter of the content.

In some methods, the system may deduct a fee or commission from payments transferred to the submitter of content, such as in an operation as part of step 144 or such as in an additional step to method 100.

In some methods, at a step 108, specific content may be requested by a user (or plurality thereof) or by a defined group of users. In other words, a request for the submission of specific content may be submitted to and/or registered at (or in) the system, at step 108. The request may be any declaration, notification of indication of the need and/or desire of a user (or plurality thereof, or group) for specific content which may be defined or described in the request.

In some methods, at any point (or time) during the execution or process of a method, the users interaction section (optionally generated at step 116) may be updated at a step 106. The update to the users interaction section at step 106 may include any change or addition to the users interaction section corresponding to any event or occurrence in the system, and/or to any execution of any of the steps of method 100. For example, the users interaction section may be added a notification that the duration since the timer has been activated (step 120) is close to the time limit (optionally set at step 118), so that users which utilize the users interaction section may know or be aware that there is not much time left to pay. For another example, when virtual commodities are transferred to the profile of a user, the details of the transfer may be posted in the users interaction section.

Referring now to FIG. 1B, there is shown a flowchart of a section 150 of some methods of the invention. Note that any or all of the steps of section 150 may be included in any method of the invention, or that otherwise any steps described for methods of the invention (preferably steps described for method 100) may be added to steps of section 150, in some methods of the invention. Step 150 may accordingly be any part of a method of the invention.

Note that referring to “the system” in the described for any sections may refer to the system described above for method 100.

Section 150 may begin at a step 110, whereat content is submitted to a platform, similarly to the described for FIG. 1A for step 110.

In some methods (referring to methods including section 150 or any of the steps thereof), a part of the content (i.e. content which have been or may be submitted at step 110) may submitted at a step 152. The part of the content may be any part, section, segment, feature, preview or component of the submitted content. Similarly, the part of the content may be any version or edition of the content. For example, submitted content may be a movie (such as in the form of a media file uploaded to a system, such as the system described for method 100), whereas a part of the submitted content may be a so called “teaser” or “trailer” of the movie, as known in the art. For another example, submitted content may be an original application (such as software), whereas a part of the submitted content (as described for step 152) may be a limited version of the application (i.e. a version lacking some of the features of the original application, such as a so-called “lite version”) or a previous edition of the application (e.g. an old edition without the new features of the original application).

Note in some methods, a part of content may be submitted at step 152 before that content has been actually submitted. Accordingly, the submission of the part of the content may be performed before, during or after the submission of the content, such as in case a submitter uploads both the content and the part of the content to a website (as an exemplary system) simultaneously. For example, the steps of section 150 (other than step 110) may be performed before submitting the content at step 110, an operation which may be performed after said steps have been performed.

In other methods, at a step 154, a part of the submitted content may be produced from the submitted content. Producing a part of the submitted content may be performed by the system, such as by a program or operation or function or procedure of the system or a section thereof. Producing a part of the submitted content may be performed automatically, such as by a processing unit and/or a processing program of the system, or manually, such as by personnel or by other users of the system. Producing a part of the submitted content may include any number of steps, such as a step for extracting relevant information or segments from the submitted content, and/or a step for editing extracted information or segments. Such steps may accordingly be included in methods of the invention, for the purpose of producing a part of content which was submitted to the system. For example, the system may analyze submitted content, such as by searching for key or main features, and composing a condensed version of the content (as an exemplary production of a part of the content) by extracting and/or manipulating said key or main features (e.g. editing the features or elements thereof). Said key or mean features may be the most frequent elements in the submitted content, such as the face of the actor in the leading role in a movie which may be the submitted content, or such as special functions in an application which may be the submitted content. Accordingly, in case the submitted content is a video, elements from the video may be captured and utilized for composing a short clip (as an exemplary part of the content) of the video, whereas in case the submitted content is an application, elements from the application (e.g. certain functions, or specifically certain segments of the code of the application) may be utilized to construct a limited version (as an exemplary part of the application) which may be an application featuring only the utilized elements and lacking any additional elements which may be included in the original application (i.e. the application which was submitted as content). For yet another example, submitted content may be a game (e.g. a video or computer game) containing any number of levels or stages, whereas at step 154 any of said levels or stages, such as levels or stage which were recognized by the system as the first few levels or stages of said game, may be copied, such as by the system or by certain users of the system, to form a short edition of said game, to be regarded as a part of the submitted content in accordance with the described herein for parts of submitted content.

Following the above, in some methods (and/or sections thereof), submitted content (as described in reference to step 110, may be modular. Preferably, the system can identify each module of submitted content and/or manipulate it separately from other modules. For example, video content (e.g. TV show) may include three segments such that the system can divide the video content to three video clips (a video clip for each segment), whereas each video clip may be regarded for the described herein as a part of the submitted content. For another example, a software (as exemplary submitted content) may include a code in which different sections correspond to different features of said software, whereas said code may mark each different section such that the system, by analyzing the code, may recognize any (or all) of the sections and extract them (e.g. copy them from the code) for producing an altered software (e.g. a different version) which may be regarded as a part of the content for the described herein. For a similar example, a computer program (as exemplary submitted content) may include plug-ins, add-ons, patches, skins and/or themes, as known in the art, which can be manipulated separately from the rest of said computer program, and/or which can be separated from said computer program. Considering the latter example, and in accordance with the described for step 152, said plug-ins, add-ons, patches, skins and/or themes may be parts of submitted content, any of which may be submitted separately to the submitted content (at step 152).

In some methods, at step 156, the part of the submitted content (submitted at step 152 or produced at step 154) may be posted (or, “publicly posted”, or “published”), or otherwise made accessible to users. Posting of the part of the submitted content may be described similarly to the described for step 140 for posting submitted content. For example, such as in case the part is a movie “trailer”, users may view the movie “trailer”, such as by streaming a video feed, thereof from the system. For another example, such as in case the part is a limited version of the content, a webpage designated for downloading the part may be generated so that users may access it for downloading the part.

In some methods, posting the part of the submitted content (step 156) may be performed before, after or during generating a users interaction section as described for step 116 of method 100 (FIG. 1A).

In some methods, after posting the part of the submitted content (and optionally the users interaction section), users may pay for the submitted content similarly to the described for step 130 of method 100. Accordingly, in some methods, a step 130 may follow step 156, whereas step 130 following step 156 may be followed by any step of method 100 (FIG. 1A) or of any sections of methods described herein. Alternatively, step 156 may be followed by any step described herein, such as by step 112 (of method 100). For example, after posting the part of submitted content (step 156, a time limit for paying for the content may be set (at a step similar to the described for step 118 of method 100).

In some methods, a price for the submitted content may be computed at a step 158. Computing the price for submitted content (i.e. for publishing the submitted content, in accordance with the described herein) may include any operation, function, execution, process or procedure for deriving a price for to set at a step 112 (see ref. FIG. 1A) which may follow step 158. For example, the system may employ any information about the submitted content, such as length and quality (information about quality may be obtained by analyzing the compression details of a file of the submitted content, such as in case said file includes video which is compressed by a certain video compression method), and/or about the user which submitted the content, such as his/her community rating (e.g. a score which may be included in the profile of the user), for concluding the most appropriate price to set at step 112, which may be the result of any computation by the system of said information. The system may additionally or alternatively employ economic models or algorithms for determining (or estimating) the worth of the submitted content.

In some methods, computing the price for submitted content (step 158) may be facilitated by collecting information from the users interaction section (optionally generated at step 116). Accordingly, at a step 159, information may be collected from the users interaction section for the purpose of deriving a price of submitted content. Said information may be provided by users (which may utilize the users interaction section to interact with each other and/or with the system) intentionally or unintentionally. For example, users may access (e.g. download or otherwise consume) a part of submitted content (in accordance with the described for steps 152, 154 and 156 for a part of the submitted content) and discuss and/or comment in the users interaction section (optionally generated at step 116) about bow much they think the submitted content is worth, whereas their opinions, such as in the form of textual comments in the users interaction section, may be analyzed by the system to compute the price for the submitted content (said opinions may preferably include or refer to a figure or value, such as for the system to calculate the average of the figures in users opinions). Note that the opinions of the users may be based on accessing the part of the submitted content. For another example, users may submit their evaluations about a reasonable price for submitted content. For yet another example, users may submit their interest in (or desire for) consuming the submitted content (without necessarily referring to a figure or value for the submitted content), whereas the system may deduce a price for the submitted content correspondingly to how many users submitted their interest. For yet another example, a poll may be conducted between users to establish a statistical agreement for a price.

Following the above, a price for submitted content may be set at a step 112 (shown in FIG. 1B following step 158) correspondingly or according to the price computed at step 158. In other words, in some methods, step 112 may follow step 158 and may be based on or influenced by the result of step 158 (i.e. a price computed by the system according to any number of factors and computation models).

Referring now to FIG. 1C, there is shown a flowchart of a section 160 of some methods of the invention. Note that any or all of the steps of section 160 may be included in any method of the invention.

Section 160 may begin at a step 130 whereat payment for submitted content is made by a user (“the submitter”), similarly to the described for step 130 of method 100 in FIG. 1A. Note that any steps described for method 100 may precede step 130 in methods which include any or all of the steps of section 160.

In some methods, at a step 162, a check for whether the submitter agrees for the submitted content to be published may be performed. In other words, the system may check if the submitter which submitted content approves the public posting (or “publishing”) of the submitted content, and/or in accordance with the described for publicly posting content, the submitter waives some or all rights (e.g. ownership) to the submitted content. Alternatively, the submitter may notify the system that he/she agrees that the submitted content will be published (in accordance with the described herein for publicly posting content, which may optionally include waiving rights for the submitted content). In case the system performs the check, the system does not necessarily communicate or interact with the submitter (i.e. the user which submitted the content), but may, in some methods, access information, such as terms or conditions previously submitted to the system under which the submitter agrees that the submitted content be published. By accessing said information, the system may determine whether said terms or conditions have been filled (or whether they exist or have occurred). In other methods, the check may be performed by contacting the submitter for receiving his/her agreement to publish the submitted content, such as by sending an email is sent to the submitter in which he/she is notified that he/she can agree to the publishing of the content.

Note that in some cases and in some methods, the check at step 162 may be performed before the total amount and/or value of payments paid for the submitted content has reached or surpassed a price set for publishing the submitted content (see ref. setting a price as described for step 112 of method 100). Similarly, the check at step 162 may be performed after a time limit (see ref. setting a time limit at step 118 of method 110) for paying for the submitted content has been reached or exceeded.

In some methods, if the submitter of content agrees for the submitted content to be published, such as in case of a positive result to a check at step 162—the submitted content may be published (also “publicly posted”) at a step 140, similarly to the described for step 140 of method 100 in FIG. 1A.

In some methods, if the submitter of content does not agree for the submitted content to be published, such as in case of a negative result to a check at step 162—the submitted content remains restricted at a step 138, similarly to the described for step 138 of method 100 in FIG. 1A.

In some methods, if the submitter of content agrees for the submitted content to be published (which may result in a positive outcome of the check at step 162) and the submitted content is published (and/or rights thereto are waived), a user profile of the submitter may be updated at a step 164. The update may be any change or modification related (or corresponding) to, or reflective of, the fact that the submitter agreed to release the content. For example, an indication of the fact that the submitter agreed to release content (which he/she had submitted) may be created in a history section (see e.g. ref. information 222b in FIG. 2B) of a user profile of the submitter.

In some methods, similarly to the described for step 148 of method 100 (see ref. FIG. 1A), updating the profile of the submitter at step 164 may include sending (also “distributing”, or “giving”, or “granting”, or “adding”, or “transferring”) virtual commodities to the profile. Otherwise, in some methods, at a step 166, credits are sent to a profile of the submitter. The sum, amount, number, type or value of credits sent to a profile of the submitter may correspond to, or represent, or reflect, any number of factors or details. Otherwise, the sum, amount, number, type or value of credits sent to a profile of the submitter may be determined by any number of factors or details. Optionally, a factor reflected in the sum, amount, number, type or value of credits sent to a profile of the submitter may be the difference between a total price for submitted content (optionally set at a step 112, in some methods) and the sum of payments made, and/or payments users are willing and/or are committed to pay, at the time when the submitter agreed to release submitted content. Additionally or alternatively, a factor reflected in the sum, amount, number, type or value of credits sent to a profile of the submitter may be the difference between a time limit (optionally set at a step 118, in some methods) and the time the submitter agreed to release submitted content.

In some methods, by agreeing for the submitted content to be published, a rank (see ref. rank 226) in the user profile of the submitter may increase, preferably representing (or “indicating”, or “reflecting”) the fact that the submitter agreed for the content to be published. Additionally or alternatively, by agreeing, virtual commodities may be sent to the user profile of the submitter. This may be beneficial for compensating the submitter in case the total amount and/or value of payments for the content did not reach or surpass a price set for publishing the content (optionally a price requested by the submitter) and/or in case the time limit for paying for the content has been exceeded.

Following the above, in some methods, a submitter of content which agrees to release (also “publish”) submitted content, even though a total price for the content is not reached, may be compensated by raising his/her rank (in accordance with the described for rank 226) and/or by receiving virtual commodities being sent to his/her profile.

Referring now to FIG. 1D, there is shown a flowchart of a section 170 of some methods of the invention. Note that any or all of the steps of section 170 may be included in any method of the invention.

In some methods (referring to methods including section 170 or any of the steps thereof), similarly to the described above for step 130, a user may pay for content to be published. As noted above, the user may be any individual interacting (directly or by utilizing any number of devices and programs) with the system, or any program, device or mechanism controlled by an individual (e.g. person) or operating on behalf of an individual. The user may similarly be a team or group, an organization, establishment, company, partnership, cooperation, business or commercial party or entity. It is therefore understood that the described for “user” in the description of section 170 (or of any step thereof) may refer to any of the options specified above.

In some methods, if the price for submitted content is reached (in accordance with the described for method 100 and specifically for step 136 of method 100), any of steps 172, 174, 176, 178 and 180 may be executed before, during or after publishing the submitted content (in accordance with the described for step 140 of method 100 and of section 160).

At step 172, an advertisement for (or of) each user which paid for the submitted content may be posted. The advertisement may be any element which can be communicated to users (e.g. which can be viewed, heard, downloaded or otherwise in any way consumed by users) and which advertises, promotes, acknowledges or congratulates the user (or plurality thereof) which paid for submitted content. Note that the described herein for “the advertisement” may not necessarily refer to commercial solicitation, but to any communicable element which features or refers to a user which paid for submitted content, preferably for the purpose of benefiting the user, such as to raise his/her community rating or reputation in a social network. However, as users may, in some methods and in some cases, be commercial parties or entities (e.g. business, such as companies), “the advertisement” may be any commercial solicitation. For example, in case a user which paid for submitted content is an individual person, at step 172, a notice may be posted in the system (e.g. in a users interaction section of the system, as described herein for methods and embodiments of the invention, and specifically shown in FIG. 2C advertisement section 248 of users interaction section 240) for publicly congratulating said individual person, such as by including his/her name in said notice. For another example, in case a user which paid for submitted content is a business or company, a commercial video clip (e.g. a video clip produced and provided by said business or company) may be broadcasted by the system.

In some methods, the advertisement may be produced and/or submitted to the system by the user which the advertisement is for. Submission of the advertisement may be a step of some methods of the invention and may be executed at any time any time during the progress of some methods of the invention, such as when the user (which the advertisement is for) registers into the system or otherwise open an account therein.

In some methods, at step 174, an advertisement (in accordance with the described above) may be added to content, preferably the content which was submitted at step 130 and for which a user which the advertisement is for made a payment. Adding the advertisement to the submitted content may refer to any attaching or linking of the advertisement to the submitted content, or any inserting of the advertisement to the submitted content. For example, the advertisement may be a video clip such that it can be edited into the beginning or end of movie content. For another example, the advertisement may be a notice which may be presented when software content is loaded by consumer of such content. For yet another example, the advertisement may be an element inserted and optionally integrated into the submitted content, such as known in the art for advanced video editing and manipulation in which “product placement” may be performed in videos already produced. Accordingly, by inserting and integrating the advertisement into the content, the advertisement may be features in the content (or in the result of the insertion and integration).

In some methods, similarly to the described above for publishing content (see ref. the described for step 140), at step 176, the owner of rights to the submitted content, preferably the user which submitted the content, may waive any or all right to the submitted content, such as by donating the submitted content to the public domain or forfeiting all ownership claims to the submitted content. Note that in some methods, the owner and/or submitter of the submitted content may have granted or otherwise transferred any or all rights to the submitted content to the system, such as when transferring the content to the system, so that step 176 may refer to the system waiving any or all rights to the submitted content (in case the system is the owner of such rights when step 176 is executed).

Note that by waiving rights to content, such as by donating (or agreeing to donate) the content to the public domain, users may not only have access to the content (e.g. for downloading), yet may also be allowed to share the content, change it and/or use it for any purpose which is legal. Further note that prior art does not provide means for waiving rights or changing ownership of content.

In some methods, submitting content may, alternatively to the described herein, refer to a user submitting to the system any means and/or information which facilitates other users accessing content which is stored at any location (e.g. a hosting service, or a memory unit of a server of the user), as opposed to being stored at the system. For example, the user may submit an IP address, a download tracker and/or a security code which can be utilized by other users to access a computer in which the content may be stored. In such methods, at step 180, access to the content may be granted to other users (similarly to the described herein for allowing access to content to users), whereas the content may be stored at any location. For example, an IP address of an FTP server, an access code to content thereat, may be posted in the system so that any user may utilize said IP address and access code to connect to said FTP server and download the content.

Referring to FIGS. 1B through 1D, note that sections 150, 160 and 170, or any number of steps thereof, or any sequence of steps thereof, may be included in methods of the invention, whereas the sections (and method 100, as a method of the invention) are shown in different figures to facilitate depiction.

Referring now to FIG. 2A, there is shown a schematic diagram of a payments representation 200 of some embodiments of a system of the invention. The described for a payments representation in methods of the invention may refer to payments representation 200.

In further detail, still referring to FIG. 2A, payments representation 200 may have payment indicators 206a-f (or simply “indicators”), each of which may represent or describe, or otherwise in any way correspond to, a payment made by a user of a system of the invention (for the publishing of submitted content, in accordance with the described for methods and embodiments of the invention, see e.g. method 100 in FIG. 1A), or information about said payment, such as specifically about the amount and/or value thereof, about the user which made said payment and/or about the time at which said payment was made. Representing (or indicating, or describing) a payment may visual, and preferably graphic. Accordingly, the payment indicators may be any visual element or object which is representative, descriptive or indicative of payments made by users, and/or of any information or details about or related to the payments, or specifically representative, descriptive or indicative of the amount, type and/or value of the payments (and/or, is some methods and some embodiments, the users which made the payments and/or the times at which the payments were made).

Following the above, in FIG. 2A, each of payment indicators 206a-f is shown corresponding to information about each payment (“PAYMENT A” through “PAYMENT F”, respectively to indicator 206a through indicator 206f) made by users for publishing submitted content. Specifically, each payment indicator is shown corresponding to a “SUM” (shown “SUM A” through “SUM F” respectively corresponding to indicators 206a through 206f), which may be any information about the amount (or “sum”) and/or value of each payment. Additionally, each payment indicator is shown corresponding to a “USER” (shown “USER A” through “USER F” respectively corresponding to indicators 206a through 206f), which may be any information about each user which made each payment. Further additionally, each payment indicator is shown corresponding to a “TIME” (shown “TIME A” through “TIME F” respectively corresponding to indicators 206a through 206f), which may be any information about the time at which each payment was made. For example, as shown in FIG. 2A, indicator 206a may visually represent “SUM A” paid by “USER A” at “TIME A”. For another example, also as shown in the figure, indicator 206f may be a visual representation of “USER F” submitted his/her commitment to pay “SUM F”, whereas the submission of the commitment may have occurred at “TIME F”. Note that the text “SUM A, USER A, TIME A” (in data specification 210), is shown connected (by a line in FIG. 2A) to indicator 206a, whereas the text “SUMP, USER F, TIME F” (in data specification 210) is shown visually to indicator 206f. It is made clear the connections between such texts in data specification 210 to indicators 206a-f are shown to exemplify how the indicators may visually correspond to information (depicted by the texts) in the data specification.

In some embodiments, the information (“SUM A” through “SUM F”, “USER A” through “USER F” and “TIME A” through “TIME F”) about each payment (“PAYMENT A” through “PAYMENT F”) may be included and/or located in a database 210a, as shown in the figure. The database may be included in a payments pool 210, such as in accordance with the described for payments pools of methods and embodiments of the invention. Accordingly, in some embodiments and methods, a payments pool may include information about payments. However, it is made clear that in some embodiments and methods, a payments pool may include only payments or the amount or value thereof (preferably serving as a storage or holder for payments, such as in case the payment pool is a bank account).

In some embodiments, the information in database 210 may be presented in payments representation 200 by data specification 210, additionally or alternatively to being represented by payment indicators 206a-f. The data specification may be any textual and/or numerical specification of all or some of the information, such as in the form of a chart. Optionally, the information in data specification 210 may be presented correspondingly to payment indicators 206a-f, specifically any information related to any payment may be presented correspondingly thereto, such as shown in FIG. 2A lines drawn from the information to the indicators, respectively. For example (alternative to lines drawn from the information to indicators), textual and/or numeral information may be presented adjacently to the indicators.

In some embodiments, payment indicators 206a-f may be located (or positioned) inside a container 202. For example, container 202 may be a bar which can be filled by representations of payments.

In some embodiments, container 202 may have a start point 204a and an end point 204b, similarly to the described for a starting point and an ending point of payments representations of methods of the invention (see ref the described specifically for step 114 of method 100). Start point 204a may correspond to, or represent, zero (or a zero sum) or to a starting amount and/or value for payments, such as an initial sum from which payments may be made and consequently payment indicators added to container 202. In other words, start point 204a may represent a beginning of a process of making payments. End point 204b may correspond to, or represent, any final amount and/or value for payments, preferably corresponding to a price set for publishing content. For example, start point 204a may correspond to a threshold amount for the first payment, such that when a payment is made that is equal or above said threshold amount, other payments can be made, whereat each of the payments (preferably including the first payment) may be represented by a payment indicator and accordingly payment indicators start to add up in container 202. For another example, end point 204b may correspond to (or be representative of) a price, as set before payments representation 200 was generated, whereas when payments are made, payment indicators progress towards end point 204b, such that when the total amount of the payments is equal to said price, payment indicators inside container 202 reach the end point.

In some embodiments, the size and/or shape and/or other features (e.g. color) of each of indicators 206a-f, or the order thereof, in case the indicators are visual elements or objects, may be representative (or “descriptive”, or “indicative”) of the amount and/or value of each payment. For example, as shown in FIG. 2A, indicator 206d may be smaller (shown as shorter) than indicator 206e for indicating the fact that a payment corresponding to (or represented by) indicator 206d is of a lower amount and/or value than a payment corresponding to (or represented by) indicator 206e, such as in case “SUM D”, which may be a paid sum represented by indicator 206d (e.g. a figure which measures the amount of payment represented by indicator 206d) is smaller than “SUM E”, which may be a paid sum represented by indicator 206e. Notice in FIG. 2A “SUM D” and “SUM E” included in database 210a and presented in data specification 210, and also presented correspondingly to indicator 206d and indicator 206e, respectively (by a line in the figure which connects “SUM D” and “SUM E” to their respective indicators). For another example, each of indicators 206a-f may have any of a scale of color shades ranging from red to green, such that the more green an indicator is, it is indicative of a larger payment, whereas the more red an indicator is, it is indicative of a smaller payment. For another example, indicators 206a-f may be arranged corresponding to the amount of payments which they represent, such as arranged in a series beginning with the indicator which represents the smallest amount and ending with the indicator which represents the largest amount.

In some embodiments, the size and/or shape and/or other features (e.g. color) of each of indicators 206a-f, or the order thereof, may be representative (or “descriptive”, or “indicative”) of the time at which each payment (which corresponds to each indicator) was made. For example, indicators 206a-f may be positioned or arranged in a series or sequence (or array) which corresponds to the times or turns at which each of the payments corresponding to the indicators was made, such that an indicator of a payment made at an earlier time or turn may be positioned before (e.g. closer to start point 204a) an indicator of a payment made later. Accordingly, indicators 206a-f may be arranged (preferably in container 202) correspondingly to the chronological order at which their respective payments were made. For example, indicators 206a-c may correspond to “PAYMENT A” through “PAYMENT C”, respectively, which may have bee paid at “TIME A” and then “TIME B” and then “TIME C”, respectively. Accordingly, in case “TIME A” is earlier than “TIME B” and “TIME B” is earlier than “TIME C”, indicators 206a-c may be arranged at a corresponding chronological order, as shown in FIG. 2A.

In some embodiments, payments pool 210 may, additionally or alternatively to including database 210a, include a payments storage 210b which may be any means for storing payments which were transferred to the system. Note that in embodiments in which the payments pool includes both payments storage 210b and database 210a, information in the database may correspond or in any way relate to payments in the payments storage (notice relation depicted in FIG. 2A by lines connecting elements in the database to elements in the payments storage (“PAYMENT A” through “PAYMENT F”).

Referring now to FIG. 2B, there is shown a schematic diagram of a user profile 220 of some embodiments of a system of the invention. User profile 220 may be, by way of example, any user profile (or simply “profile”) as described herein (see e.g. the described for updating a user profile at step 134 of method 100).

In further detail, still referring to FIG. 2B, user profile 220, similarly to the described herein for user profiles in methods of the invention, may be (or may include, or be included in) any section of (or “in”) a system (of the invention) associated with a user (who the profile is of), such as an account, membership or personal webpage. Alternatively, user profile 220 may be (or may include, or be included in) any program and/or device which is owned and/or operated (or controlled) by a user (who the profile is of), which is not necessarily a part of the system but which may be interacting or communicating with a system of the invention. For example, user profile may be a so-called “client” application which may be installed on a computer of a user and which may be connected to, or which can communicate with, a system of the invention.

In some embodiments (of profiles as described for systems of the invention), user profile 220 may include any information or details related to (or about) a user (who the profile is of), such as information 222a-c, as shown in FIG. 2B.

In some embodiments, information 222a may be (or include) details about and/or a description of the user to which profile 220 is of (or simply “USER A” in accordance with the shown in FIG. 2A).

In some embodiments, user profile 220 may be of a person or individual, and accordingly information 222a may be (or include) personal details about “USER A”, such as his/her name, birth date and/or address. Additionally or alternatively, information 222a may include a username and a password, with which a user may log into user profile 220.

In some embodiments and in some cases, user profile 220 may be of any entity (as an exemplary “USER A”) which includes more than one individual, such as a team, group, business, commercial party or organization. Information 222a may accordingly be or include any details about and/or description of said entity, such as date of establishment, slogan, logo and/or number of members (or participants or employees).

In some embodiments, information 222b may be (or include) a history (or record, log, listing or database) of actions or operations performed by “USER A” in the system, and/or interactions between “USER A” and the system and/or other users of the system. For example, information 222b may include a log of events or occurrences related to “USER A” and to the system, such as operations performed by the system which involved “USER A” and/or the profile thereof (i.e. user profile 220). For a more specific example, information 222b may include a list of all payments made by “USER A” (in accordance with payments for content as described herein). For another specific example, information 222b may include all messages submitted by “USER A” and all messages submitted by other users which mention, or which are addressed to, “USER A”.

In some embodiments, information 222c may be or include statistics (or “statistical information”) about actions or operations performed by “USER A” in the system or by utilizing and/or interacting with the system. For example, information 222c may include statistical details which are the result of analyzing payments made by “USER A”, such as their rate (i.e. the average time passed between each payment), their average amount, or such as the types of content (e.g. genres of movies) “USER A” paid for (e.g. divided to a percentage for each type). This may be beneficial for “USER A” to keep track of his activities, and/or to users which may wish to review statistical information about “USER A”, such as his/her involvement in paying for content, or his/her preferences.

In some embodiments, user profile 220 may include virtual commodities 224 which may be virtual commodities (and/or any number of representations thereof) in accordance with the described for virtual commodities in methods of the invention (see e.g. ref. step 148 of method 100). The virtual commodities may be received or collected from any number of sources, such as from a certain section of a system of the invention (e.g. a unit which can distribute certain types of virtual commodities to profiles of users), and/or from another system which can send or transfer virtual commodities to (and/or post representations thereof in) user profile 220. Optionally, any amount or number of virtual commodities 224 may be exported (or otherwise sent) from user profile 220, whereas any information about virtual commodities 224 may be retrieved by accessing user profile 220 (see ref. exporting means 230). For example, a users interaction section of the invention may access user profile 220 to obtain information about how much virtual commodities the user (which the user profile is of) has, such as for posting said information.

In some embodiments, the user (which user profile 220 is of) may utilize the user profile to indicate or notify other parties of any information about virtual commodities 224 in the user profile. For example, joining a group in a social network website may require anyone who wishes to join to have above a certain amount of a certain type of virtual commodities. User profile 220 (specifically exporting means 230 as described below) may then be utilized to provide said group with the appropriate information.

In some embodiments, as noted, above, any amount or number of virtual commodities 224, and/or any information about virtual commodities 224, may be exported (or otherwise sent) from user profile 220, by exporting means 230 of user profile 220. Accordingly, a user (which user profile 220 is of) may utilize exporting means 230 for sending virtual commodities 224 from user profile 220 to any destination. For example, joining a group in a social network website may require anyone who wishes to join to transfer a certain amount of a certain type of virtual commodities to the possession of said group. Exporting means 230 may accordingly be utilized to send said certain amount of virtual commodities from user profile 220 to the possession of said group (such as for the purpose of allowing a user, which user profile 220 is of, to join said group).

in some embodiments, user profile 220 may include rank 226. Rank 226 may be any measurement, quantity or value (e.g. number, figure or score) indicative of the amount of contribution of a user (which user profile 220 is of) and/or any visual representation of said measurement, quantity or value. Preferably, rank 226 may be the result of any computation which includes any or all of the following factors (e.g. as variable in an equation): the number of contents submitted by said user, the quality of contents submitted by said user (see ref feedback 258 in FIG. 2C), the amounts of payments transferred to said user (in accordance with the described for step 144 of method 100) and the amount of participation of said users in users interaction sections (e.g. the number of comments made by said user in a discussion conducted between users accessing a certain users interaction section of a system of the invention, or the frequency with which said user logs into the system).

In some embodiments, user profile 220 may include bandwidth capacity 228. Bandwidth capacity 228 may be any number of allocations of bandwidth with which a user (which user profile 220 is of) may access and/or interacts with a system of the invention, such as for downloading content and/or for viewing user profiles of other users. Optionally, allocation of bandwidth of bandwidth capacity 228 may correspond (or be proportional) to rank 226, or in any way factor rank 226. For example, user profile 220 may have a higher rank 226 than another user profile, and so the user which user profile 220 is of may download content faster (by having a larger bandwidth allocation) than a user which said another user profile is of.

In some embodiments, bandwidth capacity 228 may include multiple allocations of bandwidth, each of said multiple allocations designated for a different interaction with a system of the invention. For example, bandwidth capacity 228 may include a first allocation of bandwidth for downloading content which a user (which user profile 220 is of) paid for, and may additionally include a second allocation of bandwidth for downloading content which said user did not pay for. Accordingly, bandwidth capacity 228 may include any number of bandwidth allocations, each of which designated for consuming (e.g. accessing or specifically downloading) different content. Each of said bandwidth allocations, which may correspond to consuming each of multiple contents, may correspond to whether a user the user profile of which includes bandwidth capacity 228) paid for a corresponding content (out of said multiple contents), and/or when said users paid, and/or how much said user paid.

Referring now to FIG. 2C, there is shown a schematic diagram of a users interaction section 240 of some embodiments of a system of the invention. Users interaction section 240 may be, by way of example, any users interaction section (or simply “interaction section”) as described herein.

In further detail, still referring to FIG. 2C, users interaction section 240 may be any section of a system of the invention which is designated for, and/or which facilitates, interactions between users and said system, and/or between users of said system.

In some embodiments, users interaction section 240 may include a content 242 which may be any content submitted to a system of the invention (simply “submitted content”), and/or any link to submitted content, such as a hyperlink for downloading the content. As described herein for submitted contents, content 242 may either be accessible to users or restricted (i.e. not accessible to users).

In some embodiments, specifically in case content 242 is restricted, users interaction section 240 may include a timer 244, in accordance with the described for activating a timer at step 120 of method 100.

In some embodiments, users interaction section 240 may include a payments representation 246, in accordance with the described herein for payments representation. For example, in case content 242 is restricted, payments representation may include dynamic visuals which track and represent payments made for the publishing of content 242 (in accordance with the described herein for publishing content).

In some embodiments, users interaction section 240 may include an advertisements section, in accordance with the described for posting advertisements (see ref. step 172 of section 170 in FIG. 1D).

In some embodiments, users interaction section 240 may include an interaction interface 250 which can be utilized by users to interact with other users and/or with a system of the invention which includes users interaction section 240 (simply “the system” for the described for users interaction section 240). For example, interaction interface 250 may be a graphic user interface (or GUI) which may be utilized by users to make payments for content 242, and/or for sending messages to other users, and/or for submitting feedback about content 242 (see ref. feedback 258), and/or for submitting requests for content (see ref. request 260).

In some embodiments, users interaction section 240 may include an interactions record 254 which may include any record of interactions of users with the system and/or with other users which are related to content 242. Optionally, record 254 may be accessible and/or presented to users utilizing users interaction section 240.

In some embodiments, users interaction section 240 may include feedback 258 which may be any information submitted by users which relates to content 242, such as opinions, ratings and tags.

In some embodiments, users interaction section 240 may include request 260 which may include any information about content which was not submitted to the system, such as a description of such content. Said content may exist but may not have been submitted to the system, or may not exist. Said information may have been submitted by a user of the system, such as by utilizing interaction interface 250, and may be defined as a request or desire for content to which said information related (e.g. for content which said information describes). For example, a social group in the system (e.g. a group of users with common interests) may have collaboratively defined content which the majority of members in said social group wish to consume, then accordingly said social group, or any representative or mechanism thereof may submit the definition (as collaboratively defined) to the system, which may register it as request 260.

Referring now to FIG. 2D, there is shown a schematic diagram of a system 270 which may include a system 277 which may be any system of the invention, or section thereof.

In further detail, still referring to FIG. 2D, system 270 may be any system which may be utilized to manage and/or share content, such as known in the art for so-called “content management systems” and “peer file sharing” (or “file sharing networks”). As shown in FIG. 2D, system 270 may include content 272 and content 274 which may be contents submitted to and/or stored at (or “by”) system 270 (contents 272 and 274 may otherwise be linked to from system 270 or any section thereof).

in some embodiments, system 270 may include and/or utilize system 277 (or otherwise communicate and/or interact with system 277). System 277 may facilitate publishing content (in accordance with the described herein for publicly posting content) included in system 270. In other words, system 270 may utilize system 277 for publishing content in accordance with the described herein, specifically the described for multiple users making payments for content to be published (see e.g. ref. the described for steps 130 and 140 of method 100).

Following the above, in some embodiments, users of system 270 may interact with system 277, or with any number of sections thereof, for paying for content such that by the total amount and/or value of payments made by users being equal or higher to a set price for the content, the content is published (e.g. a user which submitted the content waives right of ownership of the content).

In FIG. 2D, by way of example, system 270 is shown including payments representation 246 and request 260 (see ref. FIG. 2C). System 270 may similarly users interaction section 240, and/or any element thereof (e.g. interaction interface 250), without necessarily including any content (e.g. omitting content 242 as shown included in the users interaction section), such that any of the described for FIG. 2C for users interaction section 240 and/or any elements thereof (e.g. feedback 258) in relation to content 242 may similarly apply to contents 272 and 274 in embodiments of system 277 as included in or utilized by system 270.

Following the described for FIG. 2D, a system of the invention may be an element, section, unit, module, part, component or constituent of any content management system and content sharing system (e.g. said system of the invention being a plug-in or add-on thereof), and may be utilized for publishing content (in accordance with the described herein for publishing content) by receiving payments from multiple source (e.g. multiple users).

Referring now to FIG. 2E, there is shown a schematic diagram of a system 280 which may include a system 288 which may be any system of the invention, or section thereof.

In further detail, still referring to FIG. 2E, system 280 may be any system utilized for social interactions of multiple users of similar interests, such as a social network, a forum or message board. As shown in FIG. 2E, system 280 may include users profiles 282 which may not be included in system 288 yet which may be accessible to the system. Further shown in FIG. 2E is system 280 including content 284 which may be any content owned and/or shared by users of system 280.

In some embodiments, system 280 may include and/or utilize system 288 (e.g. as an application or feature, such as known for Facebook apps) for facilitating multiple users of system 280 paying for content to be published in system 280 and/or shared between users of system 280. For example, as shown in FIG. 2E, system 288 may include payments representation 246 (see ref. FIG. 2C) for the purpose of representing payments made by users of system 280.

In some embodiments, system 288 may include request 260 (see ref. the described for users interaction section 240) which may include any information (preferably submitted by users of system 280) about content which users of system 280 wish to have access to, such as for posting that content in system 280. Payments for such content may be made regardless of the existence of such content, such that content creators may have incentive to create such content and collect to total amount and/or value of the payments.

In some methods of the invention, a step for allowing a user to join (or access) system 280 may be included. The step may be executed only when certain terms are met, preferably as consequence of other steps described for methods of the invention. For example, a condition for a user to be allowed to join system 280 may be for said user to pay for content which was requested by users of the system (e.g. content which is described in request 260 of system 288). Accordingly, said user may pay (in accordance with the described for paying for content, see ref. step 130), preferably by utilizing system 288 of system 280, after which said user is allowed to join system 280 (e.g. a restriction for said user to join the system may be removed at a step a method of the invention).

Referring now to FIG. 3A, there is shown a schematic layout of a system 300 of the invention.

In further detail, still referring to FIG. 3A, system 300 may include a front end 310 which may be any interface known in the art, such as a graphic user interface (GUI). Otherwise, front end 310 may be any element, part, section, area, modules, components or constituent of system 300 which facilitate interactions of users (see e.g. ref user 330) with system 300. Front end 310 may include any number of elements, parts, sections, areas, modules, components or constituents. Elements, parts, sections, areas, modules, components or constituents of front end 310 may be for output and/or input (e.g. may facilitate input to and output from system 300), such as for presenting users with graphics and for receiving information (as exemplary input) from users. For example, front end 310 may be a webpage having text, images, links (also “hyperlinks”), menus and input fields. For another example, front end 310 may be an interface of a computer application including a work area, a toolbar, a menu and/or an information window.

In FIG. 3A, there is shown user 330 interacting (or “interfacing”) with front end 310. User 330 may be any user of system 300, or any means which facilitate a person or group interacting with front end 310 (in accordance with the described herein for users). For example, user 330 may be a person. For another example, user 330 may be a person and a computer connected to system 300. For another example, user 330 may be a program with which a person communicates with system 300.

In some embodiments, front end 310 may include a payment section 312 in which users can pay for content submitted to system 300 (in accordance with the described herein for submitted content). In other words, payment section 312 may be part of front end 310 and may facilitate paying for submitted content. Optionally, users may utilize payment section 312 to pay for submitted content. For example, payment section 312 may be a webpage, or a sequence thereof, in which users may transfer currency from their bank accounts to system 300 or to a bank account of a submitter of content.

Note that it is to be made clear that payment section 312 may, additionally or alternatively to the described above, facilitate, or be utilized for, registering commitments, agreements, intentions, willingness, desire or obligation of users to pay for submitted content, similarly to the described herein for making payments.

In some embodiments, payments made in payment section 312, or by utilizing payment section 312, or submitted to payment section 312, may be sent (or “transferred”) to a payments pool 332. Additionally or alternatively, commitments, agreements, intentions, willingness, desire or obligation to pay, submitted to system 300 (e.g. by utilizing payment section 312), may be sent to and optionally registered (or recorded) at payments pool 332. Accordingly, payments pool 332 may be or include any storage for payments, and/or any record of payments, and/or record commitments, agreements, intentions, willingness, desire or obligation to pay, and/or record of any information related to payments, such as about users making payments.

In some embodiments, front end 310 may include a payments representation 314 which may visually represent payments and/or any information or details related to payments (e.g. by displaying or showing graphic depiction), such as payments made in (or by utilizing) payment section 312. Accordingly, payments representation 314 may include visual representations of payments and/or information or details related to payments. For example, payments representation 314 may show visual elements (e.g. graphic symbols) and/or numbers (e.g. measurements) which correspond to details about payments made in payment section 312.

Note that in some embodiments, payments representation 314 may be similar to payments representation 200 (see ref. FIG. 2A).

In some embodiments, front end 310 may include a users interaction section 316 which may be any section of system 300 which facilitates interactions between users and system 300. Optionally, users interaction section 316 may be any section of system 300 in which users may interact with each other, such as a forum, a message board, a chat-room or a comments area. For example, in some embodiments, by utilizing users interaction section 316, users may chat, exchange messages and/or discuss anything, preferably anything related to submitted content, and/or to the submitter of the content, and/or to the price for the content, and/or to paying for the content.

Note that in some embodiments, users interaction section 316 may be similar to a users interaction section as described for method 100 in FIG. 1A (see ref. step 116).

In some embodiments, front end 310 may include profiles info 318 which may be any information or details, or presentation or display thereof, related to profiles of users of system 300. Otherwise, profiles info 318 may be any information or details from users profiles (e.g. information stored in users profiles) which may be accessible through front end 310. Profiles info 318 may be located anywhere in front end 310 or included in any of front end 310. For example, profiles info 318 may be information in profile pages (e.g. pages in a website), each of the profile pages devoted to a different user of system 300. For another example, information 318 may be details displayed correspondingly (e.g. adjacently) to messages of users in users interaction section 316 (e.g. messages sent by users utilizing interaction section 316).

In some embodiments, profiles info 318 may correspond to users profiles, or to information or details therein. Otherwise, profiles info 318 may be retrieved (also “extracted”, or “obtained”, or “updated”) from profiles of users of system 300. For example, as shown in FIG. 3A, profiles info 318 may be retrieved from user profile 328a and/or from user profile 328b. User profiles 328a,b may be a storage or records of information or details related to (or “about”) users of system 300, such as a database or sections of a database. Otherwise, user profiles 328a,b may be accounts of users, or any section of system 300 designated (also “devoted”, or “allocated”) for users, and/or for information or details about users. For example, user profile 328a may be an account of user 330 in system 300. For a more specific example, user profile 328a may be a section of a database of system 300 which may be devoted to user 330, such as by storing details about user 330 and/or recording all interactions of user 330 with system 300 (e.g. personal details about user 330 and/or payments made by user 330 utilizing payment section 312).

Note that in some embodiments, user profile 328a and/or user profile 328b may be similar to user profile 220 (see ref. FIG. 2B).

In some embodiments, front end 310 may include a submission section 322 in which users (or any other party) can submit content to system 300. Otherwise, submission section 322 may be part of front end 310 and may facilitate submitting content. Optionally, users (or any other party) may utilize submission section 322 to submit content. Otherwise, users (or any other party) may submit content to (or in) submission section 322.

In some embodiments, content submitted to (or in) submission section 322, or by utilizing submission section 322, may be sent to and/or stored in a content hosting 324. Content hosting 324 may be any storage or hosting section of system 300 in which content may be stored. Optionally, content may be downloaded from content hosting 324.

In some embodiments, front end 310 may include a content section 320. Content section 320 may be any presentation of content. Otherwise, content section 320 may be any element, object, part, section, area, object or module in which content may be presented. Additionally or alternatively, content section 320 may be any element, object, part, section, area, object or module of (also “in”) front end 310, in which users may access content, or which facilitate accessing (e.g. downloading) content by users. Optionally, content is presented or accessed from content hosting 324. For example, content section 320 may present a video clip in a webpage which is part of front end 310, such as by streaming (as known in the art) the video clip from content hosting 324. For another example, content section 320 may be a button or hyperlink which, by being clicked (e.g. in a browser application), initiates downloading of content, optionally from content hosting 324.

Following the above, it is to be made clear that content may be presented to users in content section 320, or by utilizing content section 320, whereas additionally or alternatively, users may access content in content section 320, or by utilizing content section 320. For example, content section 320 may be a section of a webpage in which a music file (as exemplary content) may be streamed to users browsing the webpage, whereas the section may additionally include a button for downloading the music file (optionally from content hosting 324). The section may alternatively include only the button, or only the streaming of the music file.

In some embodiments, content may be sent (e.g. streamed or downloaded) or presented to users (otherwise accessed by users) through bandwidth capacities, or by utilizing bandwidth capacities. Otherwise, system 300 may have bandwidth capacities with which users may be presented with content, or with which users may access content. Optionally, different bandwidth capacities are allocated for different users. For example, as shown in FIG. 3A, a bandwidth capacity 334 may be allocated for user 330. Optionally, content may be presented to user 330 in content section 320 through bandwidth capacity 334, or by utilizing bandwidth capacity 334, such as by streaming the content through bandwidth 334 in case the content is a media file (e.g. an AVI or MP3 file). Additionally or alternatively, content may be accessed by user 330 directly from content hosting 324 through bandwidth capacity 334, or by utilizing bandwidth capacity 334, such as by being downloaded directly from content hosting 324 by utilizing bandwidth capacity 334.

Note that optionally, bandwidth capacity 334 may be similar to bandwidth capacity 228 (see ref. FIG. 2B), or to any allocation of bandwidth thereof.

In some embodiments, system 300 may include a bandwidth allocator 336 which may manage and/or allocate bandwidth capacities (or simply “bandwidths”) for different users and/or for different content. Managing and/or allocating bandwidths may correspond to, or depend on, any number of factors or details, such as credits in profiles of users (see e.g. ref. credits 224 of user profile 220 in FIG. 2B).

Note that it is to be made clear that payments pool 332, content hosting 324, user profiles 328a,b and bandwidth allocator 336 are shown in FIG. 3 as included in some embodiments of system 300. Accordingly, some embodiments of system 300 may include any or all of payments pool 332, content hosting 324, user profiles 328a,b and bandwidth allocator 336. Optionally, payments pool 332, content hosting 324, user profiles 328a,b, and/or bandwidth allocator 336 may be elements, parts, sections or modules of a back end of system 300.

Further note that some embodiments of system 300 include front end 310 which may include any or all of payments representation 314, payment section 312, submission section 322, users interaction section 316, part of content 326, content section 320 and profiles info 318.

Further note that any of the elements, part, section, areas, modules, components or objects of front end 310 (e.g. payments representation 314 and profiles info 318) may be presented or organized in any arrangement or order, and may be accessed or interacted with separately or in any combination. For example, profiles info 318 may be arranged in multiple pages of a website (as an exemplary system 300), whereas payment section 312 may be located in a specific separate page designated for paying for content.

Referring now to FIG. 3B, there is shown a schematic layout of a system 350 of the invention.

In further detail, still referring to FIG. 3A, system 350 may be any system which can facilitate any of the steps (or sequences thereof) described for methods of the invention.

In some embodiments, system 350 may include means 352 for submitting content to the system. See ref. step 130 of method 100. Accordingly, means 352 may facilitate users submitting content to the system, in accordance to the described herein for submitting content. For example, means 352 may include software and/or hardware, and preferably an interface, which may be utilized to upload information to servers of the system.

In some embodiments, system 350 may include means 354 for collecting payments from users of the system, preferably multiple payments from multiple users. Accordingly, means 354 may facilitate receiving or gathering payments. For example, means 354 may be a financial transaction service which can facilitate transferring currency from a plurality of sources.

In some embodiments, system 350 may include means 356 for storing payments. See ref. the described for a payments pool for step 128 and step 146 of method 100. Accordingly, means 356 may facilitate storing payments (in accordance with the described herein for payments). For example, means 356 may be a bank account or an escrow service. Optionally, payments may be stored together by means 356, such as added to each other for a combined sum. Note that in such cases, information about each payment may still be recorded and is not necessarily lost when payments are added by means 356.

In some embodiments, system 350 may include means 358 for generating a representation of payments, preferably a visual representation. See ref. step 114 of method 100. Accordingly, means 358 may facilitate generating a representation for payments, such that said representation is indicative, reflective or descriptive of payments and/or of any related information (e.g. information about users which made the payments).

In some embodiments, system 350 may include means 360 for allocating different bandwidths (or “bandwidth capacities”) to different users, and preferably for different interactions of each user with the system (and/or with other users). See ref. step 149 of step 100. Accordingly, means 360 may facilitate managing communication resources, specifically bandwidth capacities provided by system 350, by allocating different bandwidth, capacities to different users and to different interactions of each user. For example, means 360 may allocate a certain bandwidth capacity for a first user and a different bandwidth capacity for a second user, and may optionally allocate a certain bandwidth for said first user accessing a first content and a different bandwidth capacity for said first user accessing a second content.

In some methods, system 350 may include means 362 for providing (e.g. generating) rating for a user of the system which corresponds to (or is influenced by, or factors) any of the following information: the number of contents submitted by said user, the quality of contents submitted by said user, the amounts of payments transferred to said user and the amount of participation of said users in users interaction sections. See ref. rank 226 of user profile 220 in FIG. 2B. Accordingly, means 362 facilitate computing information related to steps of methods of the invention, preferably specifically related to users and/or their actions, as described for steps of methods of the invention.

In some embodiments, system 350 may include means 364 for publishing content submitted to the system (in accordance with the described herein for publishing content). See ref step 140 of method 100 and step 180 of section 170 (FIG. 1D). Accordingly, means 364 may facilitate any access of to content. For example, means 364 may be a routing service for connecting between users and a hosting service whereat content may be stored. For another example, means 364 may broadcast or distribute content to any user of system 350.

In some embodiments, system 350 may include means 366 for restricting access to content. See ref. step 138 of method 100. Accordingly, means 366 may facilitate preventing access from users to content. For example, means 366 may be a security or encryption mechanism which blocks unauthorized access to content.

In some embodiments, system 350 may include means 368 for integrating advertisements into content. See ref step 174 of section 170. Accordingly, means 368 may facilitate adding (e.g. inserting) advertisements to content.

In some embodiments, system 350 may include means 370 for generating (or “producing”) new content (as described for a part of content). See ref. step 154 of section 150 (FIG. 1B). Accordingly, means 370 may analyze, manipulate, edit, reprogram or in any way compute content submitted to system 350 for producing different content, preferably a smaller, shorter and/or limited version of the submitted content.

In some embodiments, system 350 may include means 372 for facilitating any changing of rights to content. See ref step 176 of section 170. Accordingly, means 372 may facilitate changing any or all right to content, such as ownership rights or copyrights, such as complete waiver of all rights or such as transferring of rights from one party to another.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A system comprising:
a) means for collecting a plurality of different payments for a single content; and
b) means for representing said plurality of different payments; and
c) means for changing ownership of said single content; and
c) means for controlling access to said single content.

2. The system of claim 1 further comprising means for managing different access speeds for said single content.

3. A method for buying content comprising the steps of:
a) setting a price for content; and
b) collecting payments from a plurality of sources; and
c) comparing the sum of said payments to said price; and
c) waiving ownership rights for said content.
